(19) United States
(12) Patent Application Publication
(10) Pub. No.: US 2026/0333326 A1
(43) Pub. Date: Oct. 22, 2026

(54) CONTROL RESOURCE SET CONFIGURATION FOR MULTIPLE NON-CONTIGUOUS CARRIERS

(71) Applicant: Lenovo (United States) Inc., Morrisville, NC (US)

(72) Inventors: Hossein Bagheri, Urbana, IL (US); Vijay Nangia, Woodridge, IL (US); Karthikeyan Ganesan, Nauheim (DE); Alexander Golitschek Edler von Elbwart, Darmstadt (DE)

(73) Assignee: Lenovo (United States) Inc., Morrisville, NC (US)

(21) Appl. No.: 19/441,772

(22) Filed: Jan. 6, 2026

(51) Int. Cl. H04W 72/0453; H04L 5/00; H04W 72/51

(52) U.S. Cl. CPC H04W 72/0453; H04L 5/0041; H04L 5/0051; H04W 72/51

(57) ABSTRACT

Various aspects of the present disclosure relate to control resource set (CORESET) configuration for multiple non-contiguous carriers. A user equipment (UE) may receive first signaling from a network equipment (NE) that indicates a set of resources of a CORESET associated with a downlink transmission. The set of resources spans a set of carriers that are non-contiguous in a frequency domain. The UE may receive second signaling that indicates to deactivate at least one first carrier of the set of carriers. The NE may deactivate the at least one first carrier, and the UE may receive the downlink transmission during a subset of resources of the set of resources associated with at least one second carrier of the set of carriers.

### TECHNICAL FIELD

The present disclosure relates to wireless communications, and more specifically to resource configuration.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive first signaling that indicates a set of resources of a control resource set (CORESET) associated with a downlink transmission (e.g., a physical downlink control channel (PDCCH) transmission), where the set of resources spans a set of carriers (e.g., frequency segments) that are non-contiguous in a frequency domain, receive second signaling that indicates to deactivate at least one first carrier of the set of carriers, and receive the downlink transmission during a subset of resources of the set of resources associated with at least one second carrier of the set of carriers.

A processor (e.g., a standalone processor chipset, or a component of a UE) for wireless communication is described. The processor may be configured to, capable of, or operable to perform one or more operations as described herein. For example, the processor may be configured to, capable of, or operable to receive first signaling that indicates a set of resources of a CORESET associated with a downlink transmission, where the set of resources spans a set of carriers that are non-contiguous in a frequency domain, receive second signaling that indicates to deactivate at least one first carrier of the set of carriers, and receive the downlink transmission during a subset of resources of the set of resources associated with at least one second carrier of the set of carriers.

A method performed or performable by a UE for wireless communication is described. The method may include receiving first signaling that indicates a set of resources of a CORESET associated with a downlink transmission, where the set of resources spans a set of carriers that are non-contiguous in a frequency domain, receiving second signaling that indicates to deactivate at least one first carrier of the set of carriers, and receiving the downlink transmission during a subset of resources of the set of resources associated with at least one second carrier of the set of carriers.

In some implementations of the UE, the processor, and the method described herein, the UE, the processor, and the method may further be configured to, capable of, or operable to deactivate, based on expiry of a timer indicated by at least one of the first signaling or the second signaling, the at least one first carrier. In some implementations, the UE, the processor, and the method may further be configured to, capable of, or operable to transmit feedback (e.g., an acknowledgement (ACK)) in response to the second signaling, and deactivate the at least one first carrier for a duration starting from a time offset (e.g., delay) with respect to at least one of reception of the second signaling or transmission of the feedback, where at least one of the first signaling or the second signaling indicates the duration or the duration is predefined (e.g., defined, preconfigured, configured). In some implementations, the UE, the processor, and the method may further be configured to, capable of, or operable to deactivate the at least one first carrier after a duration, where at least one of the first signaling or the second signaling indicates the duration. In some implementations, the UE, the processor, and the method may further be configured to, capable of, or operable to transmit third signaling that indicates a capability of the UE to jointly deactivate multiple carriers of the set of carriers, where the at least one first carrier includes the multiple carriers based on the capability. In some implementations, the UE, the processor, and the method may further be configured to, capable of, or operable to transmit third signaling that indicates a maximum counter value over a duration associated with deactivation and reactivation of respective carriers of the set of carriers.

In some implementations, the first signaling indicates a maximum numerical quantity of downlink transmission candidates to monitor within the CORESET, where the set of resources includes a set of control channel elements (CCEs), and where to receive the downlink transmission, the UE, the processor, and the method may further be configured to, capable of, or operable to apply, based on the second signaling, a CCE to downlink transmission candidate mapping. In some implementations, the second signaling includes at least one parameter that indicates to apply the CCE to downlink transmission candidate mapping or an additional CCE to downlink transmission candidate mapping. In some implementations, the UE, the processor, and the method may further be configured to, capable of, or operable to determine the CCE to downlink transmission candidate mapping based on a numerical quantity of available CCEs at a time deactivating the at least one first carrier. In some implementations, downlink transmission candidates associated with the downlink transmission are within respective carriers of the set of carriers based on the CCE to downlink transmission candidate mapping. In some implementations, downlink transmission candidates associated with the downlink transmission are distributed across the at least one second carrier based on the CCE to downlink transmission candidate mapping. In some implementations, to apply the CCE to downlink transmission candidate mapping, the UE, the processor, and the method may further be configured to, capable of, or operable to map downlink transmission candidates associated with the downlink transmission based on the maximum numerical quantity of downlink transmission candidates and one or more available CCEs, where the subset of resources of the set of resources includes the one or more available CCEs. In some implementations, to apply the CCE to downlink transmission candidate mapping, the UE, the processor, and the method may further be configured to, capable of, or operable to discard one or more downlink transmission candidates of a set of downlink transmission candidates associated with the downlink transmission based on the one or more downlink transmission candidates being associated with the at least one first carrier.

In some implementations, the set of resources includes a set of CCEs, where a CCE includes a set of resource element group (REG) bundles, where a REG bundle includes a set of contiguous REGs, and where a REG includes a set of contiguous resource elements (REs) or subcarriers in a symbol, and where to receive the downlink transmission, the UE, the processor, and the method may further be configured to, capable of, or operable to apply, based on the second signaling, a CCE to REG mapping. In some implementations, the second signaling includes at least one parameter (e.g., flag, field, value, indicator) that indicates to apply a first CCE to REG mapping or a second CCE to REG mapping. In some implementations, the first CCE to REG mapping is an interleaved mapping and the second CCE to REG mapping is a non-interleaved mapping. In some implementations, an interleaved mapping maps non-contiguous REG bundles to a CCE, and a non-interleaved mapping maps contiguous REG bundles to a CCE.

In some implementations, the second signaling indicates that the at least one first carrier is deactivated for at least one of the downlink transmission or a data transmission. In some implementations, the first carrier is deactivated by the second signaling for the purpose of control channel monitoring, while data communication is still possible over the first carrier. In some implementations, the set of carriers are associated with a first demodulation reference signal (DMRS) pattern, and the UE, the processor, and the method may further be configured to, capable of, or operable to apply, based on the second signaling, a second DMRS pattern to the at least one second carrier, where the first DMRS pattern is different from the second DMRS pattern. In some implementations, the UE, the processor, and the method may further be configured to, capable of, or operable to decode, based on deactivating the at least one first carrier and using the second DMRS pattern, the downlink transmission. In some implementations, the second DMRS pattern includes one or more first DMRS REs associated with the subset of resources, and the second DMRS pattern includes one or more second DMRS REs different from the one or more first DMRS REs.

An NE (e.g., a base station) for wireless communication is described. The NE may be configured to, capable of, or operable to perform one or more operations as described herein. For example, the NE may be configured to, capable of, or operable to transmit first signaling that indicates a set of resources of a CORESET associated with a downlink transmission, where the set of resources spans a set of carriers that are non-contiguous in a frequency domain, transmit second signaling that indicates deactivation of at least one first carrier of the set of carriers, and transmit the downlink transmission during a subset of resources of the set of resources associated with at least one second carrier of the set of carriers, where the at least one first carrier is different from the at least one second carrier.

A processor (e.g., a standalone processor chipset, or a component of an NE) for wireless communication is described. The processor may be configured to, capable of, or operable to perform one or more operations as described herein. For example, the processor may be configured to, capable of, or operable to transmit first signaling that indicates a set of resources of a CORESET associated with a downlink transmission, where the set of resources spans a set of carriers that are non-contiguous in a frequency domain, transmit second signaling that indicates deactivation of at least one first carrier of the set of carriers, and transmit the downlink transmission during a subset of resources of the set of resources associated with at least one second carrier of the set of carriers, where the at least one first carrier is different from the at least one second carrier.

A method performed or performable by an NE (e.g., a base station) for wireless communication is described. The method may include transmitting first signaling that indicates a set of resources of a CORESET associated with a downlink transmission, where the set of resources spans a set of carriers that are non-contiguous in a frequency domain, transmitting second signaling that indicates deactivation of at least one first carrier of the set of carriers, and transmitting the downlink transmission during a subset of resources of the set of resources associated with at least one second carrier of the set of carriers, where the at least one first carrier is different from the at least one second carrier.

In some implementations of the NE, the processor, and the method described herein, the NE, the processor, and the method may further be configured to, capable of, or operable to deactivate, based on expiry of a timer indicated by at least one of the first signaling or the second signaling, the at least one first carrier. In some implementations, the NE, the processor, and the method may further be configured to, capable of, or operable to receive feedback in response to the second signaling, and deactivate the at least one first carrier for a duration starting from a time offset with respect to at least one of transmission of the second signaling or reception of the feedback, where at least one of the first signaling or the second signaling indicates the duration. In some implementations, the NE, the processor, and the method may further be configured to, capable of, or operable to deactivate the at least one first carrier after a duration, where at least one of the first signaling or the second signaling indicates the duration. In some implementations, the NE, the processor, and the method may further be configured to, capable of, or operable to receive third signaling that indicates a capability of a UE to jointly deactivate multiple carriers of the set of carriers, where the at least one first carrier includes the multiple carriers based on the capability. In some implementations, the NE, the processor, and the method may further be configured to, capable of, or operable to receive third signaling that indicates a maximum counter value over a duration associated with deactivation and reactivation of respective carriers of the set of carriers.

In some implementations, the first signaling indicates a maximum numerical quantity of downlink transmission candidates within the CORESET, where the set of resources includes a set of CCEs, and where to transmit the downlink transmission, the NE, the processor, and the method may further be configured to, capable of, or operable to apply, based on the second signaling, a CCE to downlink transmission candidate mapping. In some implementations, the second signaling includes at least one parameter that indicates to apply the CCE to downlink transmission candidate mapping or an additional CCE to downlink transmission candidate mapping. In some implementations, downlink transmission candidates associated with the downlink transmission are within respective carriers of the set of carriers based on the CCE to downlink transmission candidate mapping. In some implementations, downlink transmission candidates associated with the downlink transmission are distributed across the at least one second carrier based on the CCE to downlink transmission candidate mapping. In some implementations, a candidate is mapped to a single carrier according to an associated CCE to REG mapping. In some implementations, the UE determines a distribution of candidates over active carriers of the set of carriers. In some implementations, the UE determines to map candidates to different carriers according to a rule, where the rule is proportional to the BW of each carrier, a carrier with a larger BW accommodates either more control candidates, and/or candidates with higher aggregation level. In some implementations, the UE can be configured with multiple CORESETs, each CORESET corresponding to one carrier of the set of carriers, upon deactivation of a carrier, the corresponding CORESET is not monitored by the UE.

In some implementations, the set of resources includes a set of CCEs, where a CCE includes a set of REG bundles, where a REG bundle includes a set of contiguous REGs, and where a REG includes a set of contiguous REs or subcarriers in a symbol, and where to transmit the downlink transmission, the NE, the processor, and the method may further be configured to, capable of, or operable to apply, based on the second signaling, a CCE to REG mapping. In some implementations, the second signaling includes at least one parameter (e.g., flag, field, sequence, code, value, indicator) that indicates to apply a first CCE to REG mapping or a second CCE to REG mapping. In some implementations, the first CCE to REG mapping is an interleaved mapping and the second CCE to REG mapping is a non-interleaved mapping. In some implementations, the second signaling indicates that the at least one first carrier is deactivated for at least one of the downlink transmission or a data transmission. In some implementations, the set of carriers are associated with a first DMRS pattern, and the NE, the processor, and the method may further be configured to, capable of, or operable to apply, based on the second signaling, a second DMRS pattern to the at least one second carrier, where the first DMRS pattern is different from the second DMRS pattern. In some implementations, the second DMRS pattern includes one or more first DMRS REs associated with the subset of resources, and the second DMRS pattern includes one or more second DMRS REs different from the one or more first DMRS REs.

### BRIEF DESCRIPTION OF THE DRAWINGS

FIG. 1 illustrates an example of a wireless communications system in accordance with aspects of the present disclosure.

FIGS. 2 through 6 illustrate examples of resource diagrams, in accordance with aspects of the present disclosure.

FIGS. 7 and 8 illustrate examples of reference signal transmission diagrams, in accordance with aspects of the present disclosure.

FIG. 9 illustrates an example of a signaling diagram, in accordance with aspects of the present disclosure.

FIG. 10 illustrates an example of a UE in accordance with aspects of the present disclosure.

FIG. 11 illustrates an example of a processor in accordance with aspects of the present disclosure.

FIG. 12 illustrates an example of an NE in accordance with aspects of the present disclosure.

FIG. 13 illustrates a flowchart of a method performed by a UE in accordance with aspects of the present disclosure.

FIG. 14 illustrates a flowchart of a method performed by an NE in accordance with aspects of the present disclosure.

### DETAILED DESCRIPTION

In a wireless communications system, a UE and an NE (e.g., a base station, a gNB) may support transmission and reception of signaling, referred to as wireless communication. For example, an NE may transmit control signaling, including downlink control information (DCI), to a UE using one or more time and frequency resources. The NE may indicate (e.g., configure, schedule, allocate) the time and frequency resources for the UE to monitor for the control signaling, such as by indicating a CORESET that includes a set of resource blocks (RBs) in the frequency domain and one or more symbols in the time domain. In some cases, the CORESET may span multiple carriers and/or frequency bands in a fragmented spectrum (e.g., non-contiguous frequency resources). A carrier may be an example of a frequency segment that includes a center frequency and a bandwidth that may span a set of contiguous or non-contiguous RBs. Monitoring for control signaling across multiple non-contiguous frequency resources using control signaling formats that do not support dynamic carrier deactivation and corresponding adjustments to CCE to downlink transmission candidate mappings or CCE to REG mappings may increase complexity at the UE, leading to inefficient resource utilization and power consumption at the UE. For example, the UE may continue to monitor CCEs and REG bundles on carriers that are not actively used for transmissions, and the UE may maintain active receiver chains for a subset of carriers that is deactivated.

As described herein, to improve resource utilization and reduce power consumption when a CORESET spans multiple non-contiguous carriers, an NE may transmit signaling to a UE that configures resources of the CORESET and that indicates deactivation of one or more carriers of the set of carriers. For example, the NE may transmit first signaling, including radio resource control (RRC) signaling or other control signaling, to a UE that indicates a set of resources of a CORESET for a downlink transmission, including a PDCCH transmission. The set of resources spans multiple carriers that are non-contiguous in a frequency domain. The NE may transmit second signaling, such as a DCI or other control signaling, that indicates to deactivate at least one carrier of the carriers. The UE uses the second signaling to adjust monitoring and resource mappings for the CORESET in response to the carrier deactivation. For example, the UE may receive and apply a CCE to downlink transmission candidate mapping or a CCE to REG mapping that accounts for the deactivation, enabling the UE to receive the downlink transmission during a subset of resources of the CORESET within another carrier of the carriers. Additionally, or alternatively, the UE may apply a different DMRS pattern to the remaining active carriers, enabling the UE to decode the downlink transmission using reference signals within the subset of resources.

By performing the described techniques, a device (e.g., a UE and/or an NE) in a wireless communications system can provide for improved resource utilization, reduced power consumption, and enhanced flexibility when a CORESET spans multiple non-contiguous carriers. For example, an NE can configure a UE with CORESET resources spanning multiple non-contiguous carriers and dynamically deactivate one or more carriers in response to traffic conditions or power saving criterion, enabling the UE to reduce monitoring complexity and conserve power by focusing on a subset of active carriers. The UE may improve spectral efficiency through adaptive CCE to downlink transmission candidate mapping and CCE to REG mapping, where the UE adjusts resource mappings in response to carrier deactivation signaling to maintain reliable reception of downlink transmissions on the remaining active carriers. Additionally, or alternatively, the UE may apply modified DMRS patterns to the active carriers following deactivation, enabling accurate channel estimation and improved decoding performance for downlink transmissions received during the subset of resources within the active carriers.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

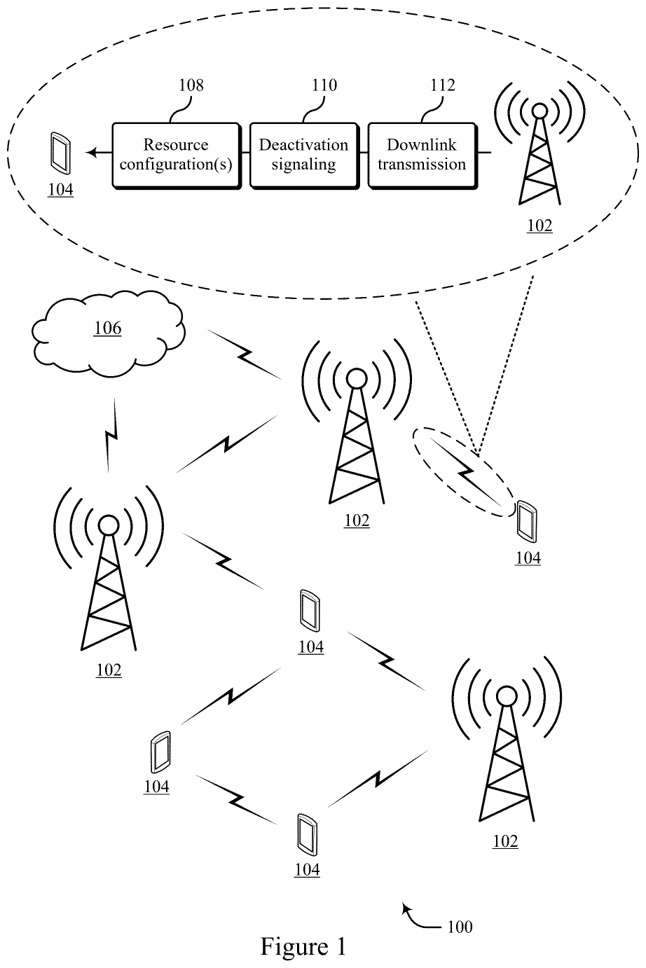

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHZ), FR4 (52.6 GHZ-114.25 GHz), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the wireless communications system 100, an NE 102 and a UE 104 may communicate using one or more time-frequency resources, such as carriers, subcarriers, symbols, slots, and the like. A carrier may refer to a frequency segment that includes a center frequency and a bandwidth. The bandwidth of a carrier may span a set of contiguous RBs or a set of non-contiguous RBs. An RB may include a set of subcarriers (e.g., 12 subcarriers) in the frequency domain and one or more symbols in the time domain. A subcarrier may be a fundamental frequency unit in OFDM systems, where multiple subcarriers are orthogonally spaced. A symbol may refer to a time-domain unit that may carry data, control information, or reference signals. A slot may refer to a basic scheduling unit for data and control transmissions in the time-domain, where a slot includes consecutive symbols. A carrier may be configured with a numerology, and different carriers may be configured with the same numerology or different numerologies. A numerology may define one or more parameters, such as subcarrier spacing, cyclic prefix length, and symbol duration, which may affect a time-frequency structure of transmissions on the carrier.

In some cases, a carrier may include a portion of a frequency band (e.g., a frequency segment), and multiple carriers may be distributed across one or more frequency bands. A frequency band may refer to a range of frequencies allocated for wireless communication, and different frequency bands may have different propagation characteristics, coverage areas, and/or bandwidth availability. The NEs 102 and the UEs 104 may communicate using one or more carriers, and the carriers may be contiguous or non-contiguous in the frequency domain. Contiguous carriers may occupy adjacent frequency resources without gaps, while non-contiguous carriers may be separated by frequency gaps or may reside in different frequency bands. In low-band frequency ranges (e.g., 700 MHz, 800 MHz, or 900 MHz bands), aggregating multiple fragmented spectrum segments (e.g., carriers) may be useful to provide a bandwidth for communication. For example, the NE 102 and/or the UE 104 may aggregate two 5 MHz fragments (e.g., frequency bands n71 and n12). Frequency band n71 may correspond to a 600 MHz band, and frequency band n12 may correspond to a 700 MHz band, both of which are low-band frequency ranges. Each fragmented spectrum segment may include a defined numerical quantity of physical RBs (PRBs). A PRB may represent a unit of resource allocation in the frequency domain, where each PRB includes a set of consecutive subcarriers (e.g., 12 subcarriers) over a defined time interval.

In some cases, the NE 102 may configure the UE 104 with a CORESET that defines a set of time-frequency resources for monitoring a downlink transmission (e.g., a PDCCH transmission). The NE 102 may configure the CORESET via control signaling, such as RRC signaling, medium access control-control element (MAC-CE) signaling, and/or downlink control information (DCI), among other examples. In some examples, the configuration may include one or more frequency domain resources, such as a bitmap indicating one or more RB groups that are included in the CORESET, and one or more time domain resources (e.g., one or more consecutive OFDM symbols), and a CCE to REG mapping type indicating whether interleaved or non-interleaved mapping is applied. For an interleaved mapping type, the UE 104 may distribute REG bundles of a CCE across the frequency domain to provide frequency diversity, where the REG bundles are spread across different frequency locations within the CORESET. For a non-interleaved mapping, the UE 104 may assign REG bundles of a CCE to contiguous frequency resources, where the REG bundles occupy adjacent frequency locations within the CORESET.

In some cases, the time-frequency resources of the CORESET may span multiple carriers or multiple frequency bands. If an NE 102 configures a UE 104 with a CORESET spanning multiple carriers that are separated by frequency gaps, then the UE 104 may monitor for DCI across the configured carriers, which may increase processing complexity and power consumption at the UE 104. In some examples, traffic conditions or network load may vary over time, and one or more carriers of the set of carriers may not be used for a transmission or during a time period (e.g., duration). In some cases, an NE 102 and/or a UE may be unable to dynamically adjust the set of carriers included in a CORESET, which may result in the UE 104 continuing to monitor resources on carriers that are not actively used for transmissions. Additionally, or alternatively, if a carrier is deactivated, then a mapping between CCEs and downlink transmission candidates, as well as a mapping between CCEs and REGs, may not account for the reduced set of available resources from the deactivated carrier. Additionally, or alternatively, if a carrier is deactivated, then a reference signal density and placement may not be updated, leading to reduced channel estimation performance on remaining active carriers. Without coordination between the NE 102 and the UE 104 regarding carrier deactivation and the corresponding adjustments to resource mappings and reference signal patterns, the UE 104 may not be able to correctly receive and decode downlink transmissions on the remaining active carriers.

According to implementations, one or more of the NEs 102 and the UEs 104 are operable to implement various aspects of the techniques described with reference to the present disclosure. For example, a UE 104 receives first signaling from an NE 102 that indicates a set of resources of a CORESET (e.g., time-frequency resources, CCEs, REGs, REG bundles, PRBs, and/or symbols) for a downlink transmission, including a PDCCH transmission. The set of resources spans a set of carriers that are non-contiguous in a frequency domain. The first signaling may be an example of a resource configuration 108, which may include RRC signaling or other control signaling, that configures the UE 104 with parameters defining the CORESET, including frequency domain resources, time domain resources, and/or CCE to REG mapping information. The resource configuration 108 may indicate a maximum numerical quantity (e.g., number, amount) of downlink transmission candidates (e.g., PDCCH candidates) to monitor within the CORESET.

In some cases, the UE 104 receives second signaling from the NE 102 that indicates to deactivate at least one first carrier of the set of carriers. The second signaling may be an example of deactivation signaling 110, which may include DCI or other control signaling, that dynamically indicates one or more carriers of the set of non-contiguous carriers are to be deactivated. The NE 102 may determine the carriers to deactivate according to traffic load, channel conditions, and/or power saving criterion. The NE 102 may transmit the deactivation signaling 110 to coordinate the carrier deactivation with the UE 104. The deactivation signaling 110 may include parameters indicating a timer for deactivation, a duration for deactivation, or a flag (e.g., indicator, field) indicating whether to apply a CCE to REG mapping or CCE to downlink transmission candidate mapping following the deactivation. As used herein, a flag may refer to a parameter, indicator, or field within signaling that conveys a binary or multi-valued state to indicate a particular configuration, mode, or action to be applied. For example, a flag may indicate whether to apply a first mapping or a second mapping, whether a carrier is active or deactivated, or whether a feature or behavior is enabled or disabled. In some cases, a flag may be included in control signaling, such as DCI or RRC signaling, and may be represented by one or more bits that a receiving device utilizes to determine how to process subsequent transmissions or adjust operational parameters.

In some cases, the UE 104 receives a downlink transmission 112 from the NE 102 during a subset of resources of the set of resources within at least one second carrier of the set of carriers. The downlink transmission 112 may include DCI (e.g., a PDCCH) and/or data transmitted by the NE 102 on the remaining active carriers after deactivation of the at least one first carrier. The UE 104 may apply a CCE to downlink transmission candidate mapping or a CCE to REG mapping in response to receiving the deactivation signaling 110 to receive and decode the downlink transmission 112 on the active carriers.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

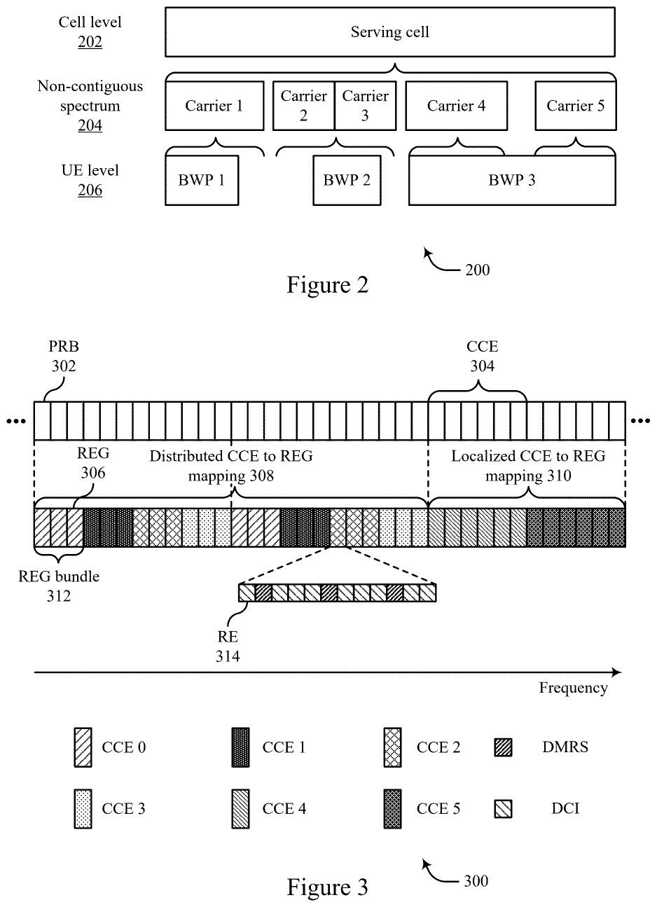

FIG. 2 illustrates an example of a resource diagram 200 in accordance with aspects of the present disclosure. In some examples, the resource diagram 200 implements or is implemented by aspects of the wireless communications system 100. For example, the resource diagram 200 may be implemented by one or more UEs and/or NEs, which may be an example of NEs 102 and UEs 104 as described with reference to FIG. 1. The resource diagram 200 illustrates an example of multiple non-contiguous spectrum segments (e.g., carriers) aggregated within a single cell configuration.

The resource diagram 200 includes a cell level 202 that represents a serving cell (e.g., a serving cell 1) spanning one or more frequency resources available for communication. A serving cell may refer to a cell (e.g., base station sector) on which a UE is configured to communicate with an NE. In some examples, the serving cell may be linked to one or more carriers in the frequency domain. For example, an NE may link the serving cell to the carriers via configuration signaling to a UE, enabling the serving cell to utilize frequency resources across the linked carriers for communication with the UE. In some cases, the serving cell at the cell level 202 may be configured to support communication across multiple non-contiguous frequency segments (e.g., carriers), where the frequency segments are treated as a single logical cell, rather than as separate component carriers with independent configurations.

The resource diagram 200 includes a non-contiguous spectrum 204. A non-contiguous spectrum 204 may refer to a set of frequency resources that are not adjacent in the frequency domain and may include multiple fragmented spectrum segments (e.g., carriers) distributed across one or more frequency bands. Although the non-contiguous spectrum 204 is illustrated as including five carriers (e.g., a carrier 1, a carrier 2, a carrier 3, a carrier 4, and a carrier 5), the non-contiguous spectrum 204 may include any numerical quantity of carriers. The carrier 2 and the carrier 3 are positioned adjacent to each other, while the carrier 1, the carrier 4, and the carrier 5 are separated by frequency gaps from the other carriers in the non-contiguous spectrum 204.

In some cases, one or more devices in a wireless communications system (e.g., 6G UEs and/or NEs) support increasingly fragmented spectrum, such as in low-band frequency ranges, as described with reference to FIG. 1. Carrier aggregation approaches in NR may be inefficient for fragmented spectrum, because each component carrier (e.g., carrier) in carrier aggregation acts as a separate cell with a distinct (e.g., unique, different) configuration, control signaling, UE capability, and feedback criterion (e.g., hybrid automatic repeat request (HARQ) criterion). The separation may create high signaling and processing overhead and may reduce scheduling flexibility, leading to inefficient use of resources.

The resource diagram 200 illustrates a single cell multi-carrier (SCMC) framework, where multiple non-contiguous carriers are treated as one cell, providing for shared configurations, joint scheduling, cross-carrier HARQ, and dynamic reuse of UE processing resources. SCMC may reduce signaling overhead by anchoring signaling while the UE is in an idle mode, such as synchronization signal blocks (SSBs), system information blocks (SIBs), and paging, on low-band carriers while enabling flexible random access channel (RACH) procedures and offloading on other carriers. In connected mode, SCMC may improve throughput and efficiency by aggregating non-contiguous spectrum, such as within a same radio frequency (RF) band group where a device may share RF chains. For example, a common RF chain may support aggregating non-contiguous spectrum in low bands. Carrier aggregation across different band groups using different RF chains may still be supported.

The resource diagram 200 includes a UE level 206 that illustrates how the carriers are organized into bandwidth parts (BWPs) for UE operation. A BWP may refer to a subset of contiguous or non-contiguous frequency resources within a carrier or across multiple carriers on which a UE 104 is configured to operate. At the UE level 206, a BWP 1 includes the carrier 1, a BWP 2 spans both the carrier 2 and the carrier 3, and a BWP 3 spans both the carrier 4 and the carrier 5. SCMC may support both single and multiple BWPs across aggregated carriers to balance scheduling simplicity, efficiency, and/or energy savings. A CORESET may span multiple carriers within a single BWP, such as BWP 2 or BWP 3, enabling aggregation of non-contiguous frequency segments for control channel monitoring and data communication.

FIG. 3 illustrates an example of a resource diagram 300 in accordance with aspects of the present disclosure. In some examples, the resource diagram 300 implements or is implemented by aspects of the wireless communications system 100 and the resource diagram 200. For example, the resource diagram 300 may be implemented by one or more UEs and/or NEs, which may be an example of NEs 102 and UEs 104 as described with reference to FIG. 1. The resource diagram 300 illustrates an example of a CORESET format.

In some cases, a CORESET may span multiple PRBs 302 in a frequency domain. For example, the CORESET may span 36 PRBs 302, as an example. The PRBs 302 may be grouped into one or more CCEs 304, where a CCE 304 is a unit of resource allocation for control channel transmissions that includes a set of REGs 306. For example, a CCE 304 may include six PRBs 302, such that a CORESET that spans 36 PRBs 302 includes six CCEs 304 (e.g., a CCE 0, a CCE 1, a CCE 2, a CCE 3, a CCE 4, and a CCE 5). A downlink transmission may include one or more CCEs 304. For example, a PDCCH includes CCEs 304 according to Table 1, where an aggregation level refers to a numerical quantity of CCEs 304 used for transmitting a single PDCCH.

TABLE 1
Supported PDCCH aggregation levels.

| Aggregation level | Number of CCEs |
|---|---|
| 1 | 1 |
| 2 | 2 |
| 4 | 4 |
| 8 | 8 |
| 16 | 16 |

An aggregation level may determine the amount (e.g., numerical quantity, number) of resources allocated for a downlink control transmission, where higher aggregation levels provide greater reliability through increased redundancy and coding gain. For example, an aggregation level of 1 corresponds to a PDCCH transmitted using a single CCE 304, an aggregation level of 2 corresponds to a PDCCH transmitted using two CCEs 304, an aggregation level of 4 corresponds to a PDCCH transmitted using four CCEs 304, and so forth. In some cases, a UE may monitor for PDCCH candidates at multiple aggregation levels within a CORESET, where the NE selects an aggregation level based on channel conditions, payload size, and/or reliability criterion. Higher aggregation levels may be used if channel conditions are poor (e.g., channel quality or other channel estimation metrics are below a threshold value) or for increased decoding reliability, while lower aggregation levels may be used to conserve resources if channel conditions are favorable (e.g., channel quality or other channel estimation metrics are above a threshold value).

In some examples, a CORESET includes

$${N}_{RB}^{CORESET}$$

RBs (e.g., INDS 302) in the frequency domain and

$${N}_{symb}^{CORESET} ∈ \{ 1 , 2 , 3 \}$$

symbols in the time domain. A CCE 304 includes 6 REGs 306, where a REG 306 includes one RB (e.g., PRB 302) during one OFDM symbol. REGs 306 within a CORESET are numbered in increasing order in a time-first manner, starting with zero for a first OFDM symbol and the lowest-numbered RB in the CORESET.

An NE can configure a UE with multiple CORESETs. Each CORESET has a CCE to REG mapping, including a distributed CCE to REG mapping 308 (e.g., interleaved) and/or a localized CCE to REG mapping 310 (e.g., non-interleaved). For distributed CCE to REG mapping 308, the REGs 306 in a CCE 304 are divided into subsets, referred to as REG bundles 312, that include less than a total number of REGs 306 in a CCE 304. For example, the REG bundles 312 may include up to six REGs 306 per symbol. In some cases, the REG bundle size may be different for different carriers. For example, a first carrier may be configured with a first REG bundle size, and a second carrier may be configured with a second REG bundle size different from the first REG bundle size. The flexibility in REG bundle size configuration enables the NE to adapt the CORESET structure to accommodate carriers with different bandwidth allocations or channel characteristics.

The REG bundles 312 are distributed across a frequency domain, such that REG bundles 312 from a same CCE 304 are separated by one or more REG bundles 312 from other CCEs 304. For a localized CCE to REG mapping 310, the REGs 306 in a CCE 304 are continuous in the frequency domain, such that REGs 306 of a same CCE 304 are adjacent. A REG bundle 312 with an index, i, is defined as REGs 306 {iL, iL+1, . . . , iL+L−1}, where L is the REG bundle size,

$$i = 0 , 1 , … , {N}_{REG}^{CORESET} / L - 1 , and {N}_{REG}^{CORESET} = {N}_{RB}^{CORESET} {N}_{symb}^{CORESET}$$

is the number of REGs 306 in the CORESET. A CCE 304 with an index, j, includes REG bundles 312 {f(6j/L), f(6j/L+1), . . . , f (6j/L+6/L−1)}, where f(·) is for interleaving. For non-interleaved CCE to REG mapping, L=6 and f(x)=x. For interleaved CCE to REG mapping, L∈{2,6} for

$${N}_{symb}^{CORESET} = 1 and L ∈ \{ {N}_{symb}^{CORESET} , 6 \} for {N}_{symb}^{CORESET} ∈ \{ 2 , 3 \} .$$

The interleaver is defined by Equation 1:

$$f ( x ) = ( rC + c + {n}_{shift} ) mod ( {N}_{REG}^{CORESET} / L ) \\ x = cR + r \\ r = 0 , 1 , … , R - 1 \\ c = 0 , 1 , … , C - 1 \\ C = {N}_{REG}^{CORESET} / ( LR ) \qquad ( 1 )$$

where R∈{2, 3, 6}. The UE may not handle configurations resulting in the quantity C not being an integer.

In some cases, an NE may configure a CORESET by transmitting a ControlResourceSet information element (IE) to a UE. The IE may configure

$${N}_{RB}^{CORESET}$$

by a higher-layer parameter frequencyDomainResources. Additionally, or alternatively, the IE may configure

$${N}_{symb}^{CORESET}$$

by the higher-layer parameter duration, where

$${N}_{symb}^{CORESET} = 3$$

is supported if the higher-layer parameter dmrs-TypeA-Position has a value of pos3. Additionally, or alternatively, the IE may configure interleaved or non-interleaved mapping by the higher-layer parameter cce-REG-MappingType. Additionally, or alternatively, the IE may configure L as being equal to six for non-interleaved mapping and by the higher-layer parameter reg-Bundle Size for interleaved mapping. Additionally, or alternatively, the IE may configure R by the higher-layer parameter interleaverSize. Additionally, or alternatively, the IE may configure n_{shift} ∈{0, 1, . . . , 274} by the higher-layer parameter shiftIndex if provided, otherwise

$${n}_{shift} = {N}_{ID}^{cell} .$$

For both interleaved and non-interleaved mapping, if the higher-layer parameter precoderGranularity equals sameAsREG-bundle, then the UE may assume a same precoding is used within a REG bundle. If the higher-layer parameter precoderGranularity equals (e.g., has the value) allContiguousRBs, then the UE may assume the same precoding being used across the REGs 306 within the set of contiguous RBs in the CORESET. The UE may assume that no REs 314 in the CORESET overlap with an SSB. In some examples, the NE may extend the CORESET duration to more than three symbols (e.g., six or twelve symbols) to compensate for small frequency allocation (e.g., for IoT).

In some cases, a CORESET may include one or more search space sets. A search space set may define a set of PDCCH candidates that a UE monitors within a CORESET, where each search space set is associated with one or more aggregation levels and a corresponding number of PDCCH candidates per aggregation level. In some cases, a search space set may be a common search space (CSS) set or a UE-specific search space (USS) set, where a CSS set may be monitored by multiple UEs and a USS set may be configured for a defined UE. For a search space set, s, associated with CORESET, p, the CCE indexes for aggregation level L corresponding to PDCCH candidate

$${m}_{s , {n}_{CI}}^{( L )}$$

of the search space set in slot

$${n}_{s , f}^{μ}$$

for an active DL BWP of a serving cell corresponding to carrier indicator field value n_{CI}, or corresponding to value n_{CI} of nCI-Value associated with a set of serving cells MC-DCI-SetofCells, are given by Equation 2:

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , m ax}^{( L )}} ⌋ + {n}_{CI} ) mod ⌊ {N}_{CCE , p} / L ⌋ \} + i . \qquad ( 2 )$$

### For a CSS,

$${Y}_{p , {n}_{s , f}^{μ}} = 0 ; for a USS , \\ {Y}_{p , {n}_{s , f}^{μ}} = ( {A}_{p} \cdot {Y}_{p , {n}_{s , f}^{μ} - 1} ) mod D , \\ {Y}_{p , - 1} = {n}_{RNTI} \neq 0 , \\ {A}_{p} = 39827 for pmod 3 = 0 , \\ {A}_{p} = 39829 for pmod 3 = 1 , \\ {A}_{p} = 39839 for pmod 3 = 2 , and$$

$$D = 65537 ; i = 0 , … , L - 1 ;$$

and N_{CCE,p} is the number of CCEs, numbered from 0 to N_{CCE,p}−1, in CORESET p and, if any, per RB set. For CORESET zero, the CCEs 304 are obtained prior to puncturing, if any, of corresponding RBs. In some cases, n_{CI} is the carrier indicator field value, if provided by cif-InSchedulingCell in CrossCarrierSchedulingConfig for the serving cell on which PDCCH is monitored, except for scheduling of the serving cell from the same serving cell in which case n_{CI}=0. In some other cases, n_{CI} is the nCI-Value provided for the set of serving cells MC-DCI-SetofCells, if MC-DCI-SetofCells is provided. Otherwise, including for any CSS, n_{CI} has a value of zero. In some cases,

$${m}_{s , {n}_{CI}}^{( L )} = 0 , … , {M}_{s , {n}_{CI}}^{( L )} - 1 , where {M}_{s , {n}_{CI}}^{( L )}$$

is the number of PDCCH candidates the UE is configured to monitor for aggregation level L of a search space set s for a serving cell corresponding to n_{CI}. For any CSS,

$${M}_{s , ma x}^{( L )} = {M}_{s , 0}^{( L )} . For a USS , {M}_{s , ma x}^{( L )}$$

is the maximum of

$${M}_{s , {n}_{CI}}^{( L )}$$

over all configured n_{CI} values for a CCE aggregation level L of search space set s. The radio network temporary identifier (RNTI) value used for n_{RNTI} is the cell-RNTI (C-RNTI).

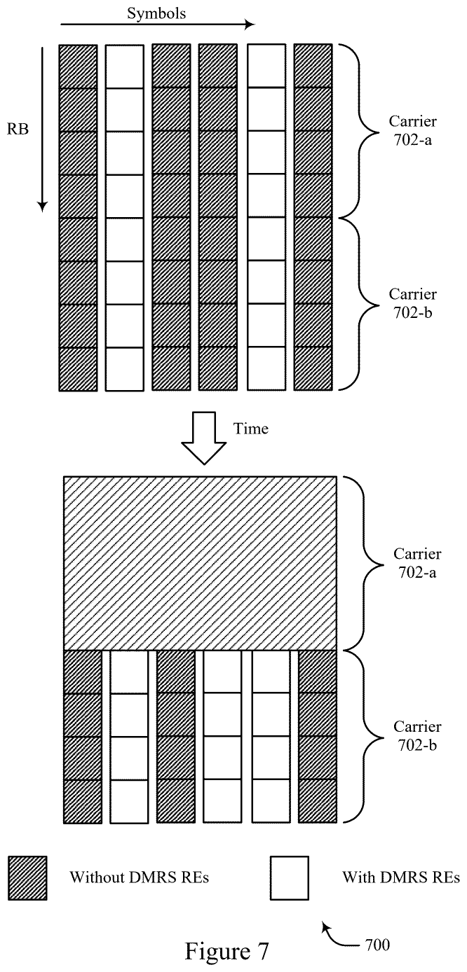

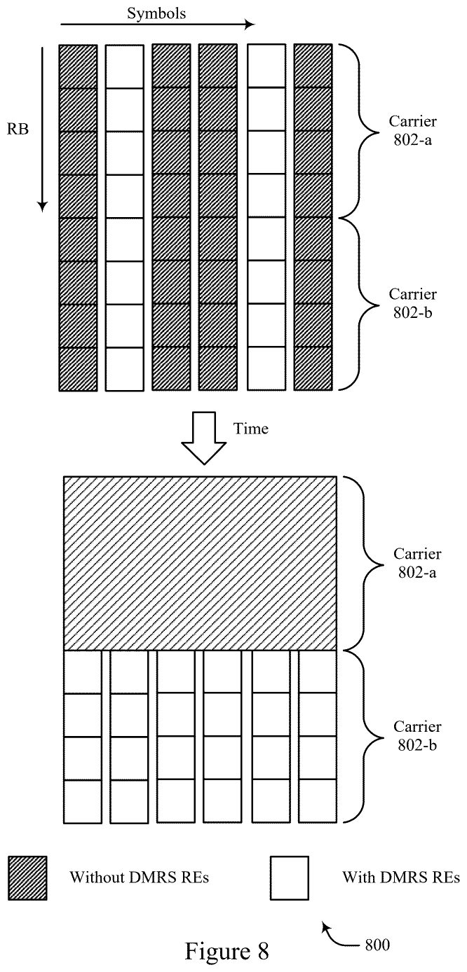

A REG 306 may span multiple REs 314, such as 12 REs 314. The REs 314 may be allocated for signaling, such as a DCI transmission or a DMRS transmission. A DMRS transmission may refer to a transmission of DMRSs within a CORESET, where the DMRS REs are distributed across REGs 306 to enable channel estimation at a receiving device. In some cases, the DMRS transmission may occupy a subset of REs 314 within each REG 306, where the remaining REs 314 may be used for DCI transmission. In some cases, the DMRS transmission may be used by a UE to estimate channel conditions for demodulating and decoding a downlink transmission, such as a PDCCH transmission, received within the CORESET. In some examples, if a CORESET spans multiple non-contiguous carriers, then the DMRS transmission pattern may be adjusted based on carrier deactivation signaling, which is described in further detail with respect to FIGS. 7 and 8.

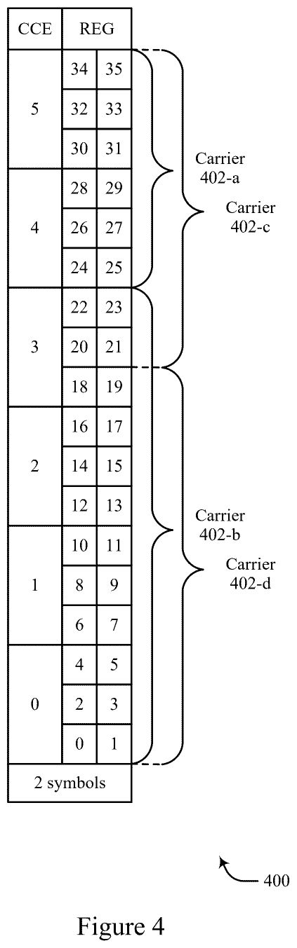

FIG. 4 illustrates an example of a resource diagram 400 in accordance with aspects of the present disclosure. In some examples, the resource diagram 400 implements or is implemented by aspects of the wireless communications system 100, the resource diagram 200, and the resource diagram 300. For example, the resource diagram 400 may be implemented by one or more UEs and/or NEs, which may be an example of NEs 102 and UEs 104 as described with reference to FIG. 1. The resource diagram 400 illustrates an example of carrier distribution according to a CCE to REG mapping.

In some examples, an NE may configure (e.g., allocate, schedule) one or more carriers according to REG bundles. For example, the NE may configure a carrier 402-a and a carrier 402-b, where REG bundles are included within the respective carriers, rather than split across carriers. The NE may refrain from configuring (e.g., may not configure) a carrier that splits REG bundles, such as the carrier 402-c and the carrier 402-d, where the REGs in CCE 3 are split between the carrier 402-c and the carrier 402-d. The UE may aggregate two or more non-contiguous carriers (e.g., frequency segments), including the carrier 402-a and the carrier 402-b. In some cases, the carriers may be within a same frequency band. In some other cases, the carriers may be on different frequency bands. Two or more aggregated non-contiguous carriers may be an SCMC or a single logical carrier. In some examples, the two or more aggregated non-contiguous carriers have a same numerology (e.g., subcarrier spacing, cyclic prefix length, slot duration, subframe duration).

In some examples, an NE may deactivate and/or reactivate one or more carriers (e.g., the carrier 402-a and/or the carrier 402-b). Deactivation of a carrier may refer to a process by which the NE instructs (e.g., indicates, configures) a UE to cease monitoring for downlink transmissions on the carrier, exclude resources of the carrier (e.g., CCEs, REG bundles, REGs) from the set of resources used for control channel monitoring, and/or optionally power down or reduce power consumption associated with receiver chains for the deactivated carrier. If a carrier is deactivated, then the UE may refrain from monitoring downlink transmission candidates (e.g., PDCCH candidates) mapped to CCEs of the deactivated carrier, and the UE may adjust CCE to downlink transmission candidate mappings and CCE to REG mappings to account for the reduced set of available resources. Reactivation of a carrier may refer to a process by which the NE instructs the UE to resume monitoring for downlink transmissions on the carrier, include the resources of the carrier back into the set of resources used for control channel monitoring, and/or restore receiver chain operation for the reactivated carrier. Upon reactivation, the UE may update the CCE to downlink transmission candidate mappings and CCE to REG mappings to incorporate the resources of the reactivated carrier.

In some examples, the NE may transmit a MAC-CE command or other control signaling that enables (e.g., reactivates, activates) or disables (e.g., deactivates) a carrier. The REG bundles of the carrier are included or excluded in the set of REG bundles a time, T1, after the reception of the MAC-CE command, where T1 is the application time. For example, if the NE deactivates the carrier 402-a, then the UE may exclude the REG bundles and CCEs of the carrier 402-a from the CORESET resources and may monitor the CCEs and REG bundles within the carrier 402-b. If the carrier 402-a includes CCE 4 and CCE 5 corresponding to REG indices 24 through 35, then upon deactivation of the carrier 402-a, the UE may monitor CCE 0, CCE 1, CCE 2, and CCE 3 corresponding to REG indices 0 through 23 within the carrier 402-b. If the NE subsequently reactivates the carrier 402-a, then the UE may include the REG bundles and CCEs associated with the carrier 402-a back into the set of CORESET resources, restoring monitoring across both the carrier 402-a and the carrier 402-b.

In some cases, a MAC-CE command or a DCI command that enables or disables frequency segments (e.g., carriers) may indicate a number of PDCCH candidates for each aggregation level. The indication of PDCCH candidates per aggregation level enables the UE to determine how many downlink transmission candidates to monitor within the CORESET following the activation or deactivation of one or more frequency segments. The UE may adjust monitoring and resource allocation in response to changes in the set of active carriers. By providing the number of PDCCH candidates per aggregation level in the activation or deactivation command, the NE and the UE can maintain alignment on the expected monitoring configuration without additional signaling exchanges.

In some examples, an activation command or a deactivation command for a frequency segment may indicate one or more parameters. For example, the activation command or the deactivation command may indicate whether the activation or deactivation is applicable for a downlink control channel (e.g., PDCCH), or for both the downlink control channel and a data channel (e.g., physical downlink shared channel (PDSCH) for downlink and/or physical uplink shared channel (PUSCH) for uplink). Additionally, or alternatively, if a frequency segment is deactivated for control channel monitoring and/or data transmission, then one or more of uplink control signaling (e.g., PUCCH, scheduling request), uplink control information on PUSCH, and/or RACH procedures may continue on the deactivated frequency segment. The configuration enables the UE to maintain uplink communication capabilities on the deactivated frequency segment, while reducing downlink monitoring complexity. Additionally, or alternatively, the activation command or the deactivation command may indicate a subset of symbols of a control channel, slot, or subframe to which the activation or deactivation is applicable, enabling time-domain granularity for carrier activation or deactivation within a transmission time interval. In some examples, the activation or deactivation may be applicable to one or more search space sets of the frequency segment, enabling the NE to selectively activate or deactivate monitoring for specific search space sets within the CORESET.

In some cases, the RBs in the aggregated spectrum are indexed logically. For CORESET construction, a fragment or segment (fi) is included (e.g., or considered as a candidate for inclusion) in the mapping if the fragment or segment has a multiple of REG bundle resources or CCE resources for PDCCH mapping. For example, RBs of a fragment are included in indexing for RBs of a CORESET if the fragment has at least 24 RBs per symbol or the fragment has at least 4 CCEs per CORESET duration. In some examples, a higher-layer parameter may be defined to indicate whether contiguous RBs or REGs share a same precoder for DMRS transmission. Based on the parameter, the UE may assume a same precoding is used across REGs within the set of contiguous RBs or REGs in the CORESET, which may facilitate channel estimation and demodulation of the downlink transmission.

In some examples, a number of symbols in the CORESET may be different for different frequency segments. For example, the CORESET in the first frequency segment may span three symbols, while in a second frequency segment may span one symbol (e.g., due to data scheduling on the second and third symbol on that segment). The REG bundle size may be six for the first frequency segment and the REG bundle size may be two for the second frequency segment, enabling the same REG bundle bandwidth (e.g., in terms of number of contiguous RBs) of two RBs in both frequency segments. In some cases, REG bundling may group multiple REGs in the time-frequency domain together, such that DMRS from REGs in the bundle are combined, leading to smoothed channel estimation across a wider frequency region. The UE may assume the same precoding is used within at least a REG bundle. For a CORESET, a REG bundle may include a numerical quantity of RBs (e.g., ‘M’ RBs) in a symbol. For example, a REG bundle may include six RBs with a one symbol CORESET duration. A carrier may be included in the CORESET if the carrier has one or more multiples of the numerical quantity of RBs per symbol. In some cases, a REG bundle may include REGs belonging to a single frequency segment. A REG bundle may not span across more than one carrier.

The resource diagram 400 illustrates the relationship between CCEs, REGs, and carriers in a CORESET spanning multiple non-contiguous frequency segments. A CCE includes one or more REG bundles, such that the number of REGs in the CCE equals a predefined value (e.g., six REGs per CCE). In some cases, REGs and REG bundles of a CCE are confined to a single frequency segment (e.g., carrier), such that the REG bundles associated with a CCE do not span across more than one frequency segment. Thus, if a carrier is deactivated, then the CCEs associated with that carrier can be excluded from monitoring without affecting the integrity of CCEs on remaining active carriers. For example, if the carrier 402-a is deactivated, then the UE may exclude CCE 4 and CCE 5 from monitoring, while continuing to monitor CCE 0, CCE 1, CCE 2, and CCE 3 within the carrier 402-b. The carrier 402-c and the carrier 402-d illustrate configurations where REG bundles are split across carrier boundaries, which may be avoided to maintain proper CCE to REG mapping integrity during carrier deactivation operations.

In some cases, a search space set defines a set of PDCCH candidates that a UE monitors within a CORESET, where each search space set is associated with one or more aggregation levels and a corresponding number of PDCCH candidates per aggregation level. The number of PDCCH candidates corresponding to each aggregation level may be adjusted based on the number of included or available frequency segments. If the carrier 402-a is deactivated, then the number of available CCEs is reduced from six (e.g., CCE 0 through CCE 5) to four (CCE 0 through CCE 3), and the number of PDCCH candidates that the UE monitors may be correspondingly adjusted based on the reduced set of available resources within the carrier 402-b.

In some examples, at least a portion of PDCCH candidates corresponding to at least a first set of aggregation levels (e.g., aggregation levels up to and including aggregation level 4) may be associated with CCEs and corresponding REG bundles that belong to a single frequency segment (e.g., an anchor frequency segment), such that the PDCCH candidates do not span across more than one frequency segment. In some other examples, PDCCH candidates corresponding to at least a second set of aggregation levels (e.g., aggregation level 8, aggregation level 16, or larger) may be associated with CCEs and corresponding REG bundles that belong to more than one frequency segment. With reference to FIG. 4, PDCCH candidates with lower aggregation levels may be mapped to CCEs within a single carrier (e.g., the carrier 402-b), while PDCCH candidates with higher aggregation levels may span CCEs across both the carrier 402-a and the carrier 402-b when both carriers are active.

In some cases, a search space set type applicable to a CORESET may be configured to span only a single frequency segment (e.g., an anchor frequency segment). For example, PDCCH candidates corresponding to a CSS may be associated with CCEs and corresponding REG bundles that belong to one frequency segment, such as an anchor frequency segment. An anchor frequency segment may be explicitly indicated as a Boolean value (e.g., yes or no) for each defined, configured, or activated frequency segment, enabling multiple anchor segments to be combined. Additionally, or alternatively, a configuration may indicate which of the defined, configured, or activated frequency segments is the anchor frequency segment (e.g., as an index value identifying one of the frequency segments). Additionally, or alternatively, the frequency segment with a lowest identifier may be assumed to be the anchor frequency segment. For example, the carrier 402-b may be designated as an anchor frequency segment, such that CSS PDCCH candidates are mapped to CCE 0, CCE 1, CCE 2, and CCE 3 within the carrier 402-b, ensuring that CSS monitoring remains available even if the carrier 402-a is deactivated.

Additionally, or alternatively, a rule can be defined (e.g., via a configured sequence), where the rule indicates an anchor frequency segment for the CSS purpose. A sequence can be configured, such as 1, 2, 3. For aggregation of 3 frequency segments, if carrier 1 is active, then CSS is contained within carrier 1. If carrier 1 is not active, and carrier 2 is active, then CSS is contained within carrier 2. If carriers 1 and 2 are not active, and carrier 3 is active, then CSS is contained within carrier 3. Additionally, or alternatively, the rule may indicate that the anchor frequency segment is the one with the lowest or highest index amongst active carriers. Additionally, or alternatively, the rule may define an anchor carrier as a carrier that is not allowed to be deactivated via a dynamic deactivation mechanism. For example, carrier 1 may be excluded from a dynamic indication of deactivation or reactivation. The carrier to be excluded for deactivation or reactivation can be configured by higher layer signaling, such as RRC signaling.

In some examples, instead of configuring a single CORESET that spans multiple non-contiguous frequency segments (e.g., carriers), an NE may configure a UE with multiple CORESETs, where each CORESET is associated with a different frequency segment. The UE monitors multiple CORESETs, rather than a single CORESET spanning multiple frequency segments, which may increase monitoring complexity at the UE. Additionally, or alternatively, larger aggregation levels may not fit within each individual CORESET due to the frequency resources available in a single frequency segment. To provide frequency diversity, PDCCH repetition may be achieved by linking search space sets corresponding to different CORESETs. For example, a first search space set associated with a first CORESET corresponding to a first frequency segment may be linked to a second search space set associated with a second CORESET corresponding to a second frequency segment. The linking enables the NE to transmit the same PDCCH across multiple frequency segments, providing improved reliability through repetition. If the second frequency segment is deactivated (e.g., based on deactivation signaling as described herein), then the UE may refrain from monitoring both the first and the second search space sets, or the UE may continue to monitor the first search space set, while refraining from monitoring the second search space set associated with the deactivated frequency segment. In some examples, the UE is configured with a first set of candidates that are not linked over more than one frequency segment and a second set of candidates that are linked over two or more frequency segments. Candidates belonging to CSS are linked over two or more frequency segments (e.g., to provide CSS candidates even if some of the frequency segments become deactivated).

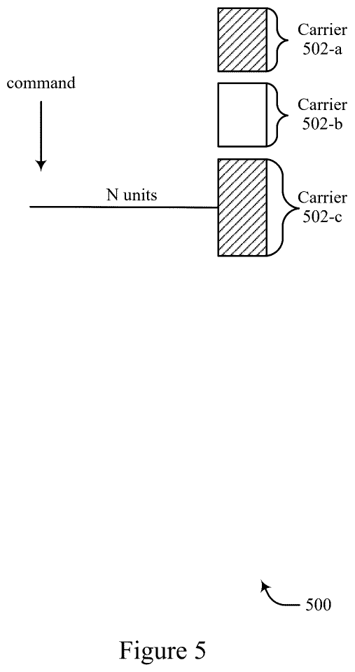

FIG. 5 illustrates an example of a resource diagram 500 in accordance with aspects of the present disclosure. In some examples, the resource diagram 500 implements or is implemented by aspects of the wireless communications system 100, the resource diagram 200, the resource diagram 300, and the resource diagram 400. For example, the resource diagram 500 may be implemented by one or more UEs and/or NEs, which may be an example of NEs 102 and UEs 104 as described with reference to FIG. 1. The resource diagram 500 includes a carrier 502-a, a carrier 502-b, and a carrier 502-c arranged in the frequency domain.

In some cases, a UE may receive a command (e.g., a MAC-CE or DCI command) that deactivates and/or reactivates one or more of the carrier 502-a, the carrier 502-b, and/or the carrier 502-c. The UE may be configured with and/or may indicate to the NE a capability indicating that up to a first numerical quantity (e.g., ‘x1’) of frequency segments (e.g., carriers) can be enabled or disabled simultaneously, or that up to a second numerical quantity (e.g., ‘x2’) of REG bundles or REGs can be enabled or disabled simultaneously. The capability may be reported by the UE to the NE via capability signaling (e.g., included in uplink control information (UCI) or other control signaling), enabling the NE to determine deactivation commands that do not exceed a processing capability of the UE. If the UE reports a capability indicating that up to two frequency segments can be enabled or disabled simultaneously, then the NE may transmit deactivation signaling that deactivates the carrier 502-a and the carrier 502-b, but may refrain from deactivating additional carriers, such as the carrier 502-c. In some other examples, if the UE reports a capability indicating that up to twelve REG bundles can be enabled or disabled simultaneously, and each of the carrier 502-a and the carrier 502-b includes six REG bundles corresponding to three CCEs per carrier, then the NE may deactivate both the carrier 502-a and the carrier 502-b. If the UE reports a capability indicating that up to six REG bundles can be enabled or disabled simultaneously or a single carrier can be enabled or disabled, then the NE may deactivate one the carrier 502-a, the carrier 502-b, or the carrier 502-c.

In some examples, the UE may not be expected to apply the activation command or the deactivation command within a CORESET duration, which may lead to missed PDCCH transmissions or decoding errors. Thus, the activation command or the deactivation command may be applicable at least a threshold number of symbols (e.g., ‘W’ symbols) prior to a first symbol of a CORESET in an upcoming monitoring occasion. The threshold number of symbols provides the UE with processing time to adjust CCE to downlink transmission candidate mappings, CCE to REG mappings, and/or receiver chain configurations before the next CORESET monitoring occasion begins.

In some cases, a UE may not update REG bundles more than a maximum counter value (e.g., ‘y’ times) in a period of time or in a duration of an active timer. The UE may report the maximum counter value to the NE via capability signaling (e.g., UCI or other control signaling), enabling the NE to manage the frequency of deactivation and reactivation commands to remain within the capabilities of the UE. If the UE reports a maximum counter value of four updates per duration for a carrier, and the NE deactivates and/or reactivates the carrier four times within the duration, then the NE may refrain from transmitting additional deactivation or reactivation commands until the duration expires or a new duration begins. Deactivation of a frequency segment (e.g., a carrier) can also be performed based on expiry of a timer. For example, if the UE has not received a PDCCH associated with CCEs or REG bundles in a frequency segment (e.g., the carrier 502-a, the carrier 502-b, and/or the carrier 502-c) for a time period (e.g., a duration of the timer, N time units), then the timer expires and the UE may deactivate the corresponding frequency segment (e.g., the carrier 502-a, the carrier 502-b, and/or the carrier 502-c).

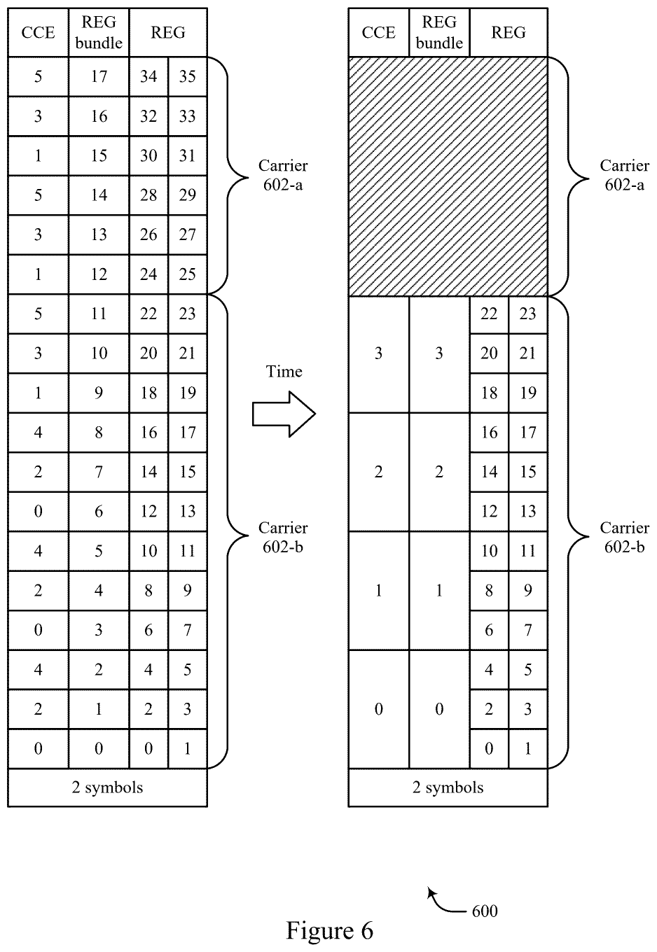

FIG. 6 illustrates an example of a resource diagram 600 in accordance with aspects of the present disclosure. In some examples, the resource diagram 600 implements or is implemented by aspects of the wireless communications system 100, the resource diagram 200, the resource diagram 300, the resource diagram 400, and the resource diagram 500. For example, the resource diagram 600 may be implemented by one or more UEs and/or NEs, which may be an example of NEs 102 and UEs 104 as described with reference to FIG. 1. The resource diagram 600 illustrates CCE to REG mapping across a carrier 602-a and a carrier 602-b, where the carrier 602-a and the carrier 602-b are non-contiguous in the frequency domain.

In some cases, the UE may be configured with a carrier 602-a and a carrier 602-b, which may be examples of carriers (e.g., frequency segments), as described with reference to FIGS. 4 and 5. The UE may also be configured with a CORESET that spans the carrier 602-a and the carrier 602-b, which may be non-contiguous in the frequency domain. The configuration of the CORESET may include a CCE to REG mapping, which may be an example of an interleaved CCE to REG mapping. The UE may receive signaling (e.g., control signaling) from an NE that deactivates a carrier 602-a. The signaling may indicate a new CCE to REG mapping and/or the UE may determine the new CCE to REG mapping based on the number of available CCEs. For example, the UE may switch to a non-interleaved mode.

In some cases, if a portion of CORESET time-frequency resources is not available (e.g., due to a command from the network), then the REG bundle size may be adjusted for the frequency segment or segments with affected time-frequency resources. For example, the REG bundle size may be initially set to 6, and a 15 RB frequency segment may be impacted by an indication indicating that 6 RBs per symbol are not available for the CORESET for a time instance or time period (e.g., due to scheduling of data on those resources). The UE may be indicated to adjust the REG bundle size to 3, or the UE may autonomously adjust the REG bundle size (e.g., for the affected frequency segment or for all frequency segments) to 3 or to a largest number or a largest possible number, where the number is smaller than the previously set number. A largest possible number may refer to a REG bundle size that provides for utilizing REGs efficiently without excluding a subset of REGs from the mapping. In some examples, the largest possible number may be selected from a set of specified or configured possible REG bundle sizes.

If the carrier 602-a initially includes 24 RBs with a REG bundle size of 6, and the NE transmits signaling indicating that 6 RBs of the carrier 602-a are unavailable for a time period, then the remaining 18 RBs may not be evenly divisible by the original REG bundle size of 6 without excluding resources. The UE may adjust the REG bundle size to 3, which provides for the 18 available RBs to be organized into 6 REG bundles without excluding any RBs from the CORESET mapping. The adjustment may be indicated explicitly by the NE via control signaling, or the UE may determine the adjusted REG bundle size autonomously based on the available resources and a set of allowable REG bundle sizes. The adjustment enables efficient utilization of the remaining CORESET resources, while accommodating dynamic changes in resource availability due to data scheduling or other network operations. The carrier 602-b may maintain original REG bundle configuration if the unavailability indication does not affect resources within the carrier 602-b.

In some examples, if a UE receives a deactivation or reactivation command for a subset of frequency segments, PDCCH candidates may be mapped to CCEs. In some cases, a set of nominal CCEs may be determined based on a pre-defined set of frequency segments. For example, if three segments are configured for the UE, then the three segments may be considered in determining nominal CCEs. The UE may be configured, as a part of search space set configuration, with a number of PDCCH candidates for each aggregation level. The UE may take into account that number in mapping PDCCH candidates to CCEs, and may discard PDCCH candidates mapped to invalid CCEs (e.g., CCEs mapped to RBs that belong to deactivated or unavailable frequency segments).

In some other cases, a PDCCH candidate may be mapped to CCEs or REG bundles from a single frequency segment, which may reduce frequency diversity. The UE may determine a number of PDCCH candidates corresponding to each aggregation level and also corresponding to each frequency segment. The information may be provided by RRC signaling, MAC-CE signaling, or DCI signaling, or may be determined based on the number of CCEs or REG bundles within each frequency segment. A field in the corresponding search space set configuration or in the activation, deactivation, or reactivation command may indicate at least one of the number (e.g., or a maximum number) of PDCCH candidates for each aggregation level and for each frequency segment; a maximum number of PDCCH candidates for an aggregation level; or the number of PDCCH candidates for each aggregation level in every frequency segment. In some cases, the number of PDCCH candidates for an aggregation level may be determined by the UE (e.g., based on a maximum number of PDCCH candidates for the aggregation level provided by the search space set configuration, or a minimum of the number of PDCCH candidates for the aggregation level provided by the search space set configuration and the maximum number of PDCCH candidates for the aggregation level).

In some examples, the UE may determine REG bundles within each frequency segment, index the REG bundles within each segment, and determine the number of CCEs in each frequency segment. For interleaved mapping with small aggregation levels (e.g., aggregation levels below a threshold value), the UE may map CCEs to REGs or REG bundles within each frequency segment. For example, the UE may determine there are eight PDCCH candidates corresponding to aggregation level 1, four candidates corresponding to aggregation level 2, two candidates with aggregation level 4, and one candidate with aggregation level 8. If there are two frequency segments each with 24 RBs, each frequency segment may include half of the PDCCH candidates for each aggregation level, except that a PDCCH candidate corresponding to aggregation level 8 may be mapped to both frequency segments. For large aggregation levels (e.g., aggregation levels greater than a threshold value), the UE may map CCEs to all or a subset of frequency segments according to a rule (e.g., a set of contiguous available CCE indices). The CCE to REG mapping may be modified according to the set of available frequency segments, where the mapping for small aggregation levels may be different than the mapping used for large aggregation levels. An aggregation level threshold for distinguishing CCE to REG mapping may be indicated to the UE via RRC signaling, MAC-CE signaling, or DCI signaling (e.g., via DCI or MAC-CE indicating an update to the set of frequency segments), or may be determined by the number of available REG bundles in each frequency segment.

In some cases, a MAC-CE or DCI may indicate a number of PDCCH candidates per aggregation level. In some examples, a CCE starting index may be determined based on the entire CCEs of the CORESET, which may facilitate use of the CORESET by multiple UEs. The starting CCE index for PDCCH candidates of a UE-specific search space set for a UE may depend on an RNTI via a UE-specific shift. For a common search space set, there may be no shift. If a CORESET spans multiple frequency segments, an entire CCEs may be considered for finding the CCE starting index. If some of the frequency segments are not available for a UE but are available for other UEs, then either a CORESET may be included in a single frequency segment, or if the CORESET spans multiple frequency segments, PDCCH candidates mapped to inactive CCEs may be discarded by the UE.

FIG. 7 illustrates an example of a reference signal transmission diagram 700 in accordance with aspects of the present disclosure. In some examples, the reference signal transmission diagram 700 implements or is implemented by aspects of the wireless communications system 100, the resource diagram 200, the resource diagram 300, the resource diagram 400, the resource diagram 500, and the resource diagram 600. For example, the reference signal transmission diagram 700 may be implemented by one or more UEs and/or NEs, which may be an example of NEs 102 and UEs 104 as described with reference to FIG. 1. The reference signal transmission diagram 700 illustrates REG bundling and DMRS RE allocation across multiple carriers.

The reference signal transmission diagram 700 includes a carrier 702-a and a carrier 702-b, which may be examples of carriers that are non-contiguous in the frequency domain. The carrier 702-a and the carrier 702-b are arranged along an RB axis in the frequency domain and a symbols axis in the time domain. In some cases, a network may reduce PDCCH DMRS overhead in time, such as when the channel has less than a threshold amount of time varying (e.g., for large CORESET durations, including six symbols). The NE may define a REG bundle to be a time domain REG bundle, such as one RB per set of contiguous symbols. For example, a REG bundle may be defined as a bundle of REGs in time and in frequency with sparse DMRS symbols.

In some cases, time transmission interval (TTI) or slot bundling may be applied in the time domain. A higher-layer parameter may be defined to indicate whether contiguous symbols share a same precoder. For each RB or REG, the UE may assume a same precoding being used across symbols within the set of contiguous symbols in the CORESET. A PDCCH candidate or CCE may be mapped to REG bundles corresponding to the same RB, which have been TTI bundled. REG bundles with size L (e.g., where L represents a numerical quantity of RBs in the frequency domain) corresponding to different symbols may be bundled together, referred to as a super-REG-bundle, and CCE to REG mapping may be performed over super-REG-bundles.

In some cases, the carrier 702-a and the carrier 702-b each include multiple RBs across one or more symbols. The RBs may include resources without DMRS REs and resources with DMRS REs. The UE may receive signaling that deactivates the carrier 702-a. The UE may deactivate the carrier 702-a and may apply a modified DMRS pattern to the active carriers (e.g., the carrier 702-b) following a configuration change or carrier deactivation. For example, the UE may be indicated which CORESET symbols carry DMRS REs. A CCE may include DMRS REs in at least one of the CCE symbols. If a symbol on one or more frequency segments is deactivated for control channel monitoring, then the symbol may not be the symbol that carries DMRS REs. In some other examples, the next available symbol of the CORESET may carry DMRS REs. If a first numerical quantity of symbols of the CORESET carrying DMRS REs are not available, then the UE may be indicated a new set of DMRS symbols in the CORESET, or the UE may determine a replacement set of DMRS symbols. The cardinality of the replacement set of DMRS symbols is a second numerical quantity less than or equal to the first numerical quantity. The DMRS symbols in the replacement set may be CORESET symbols which did not have DMRS REs prior to the indication or determination of unavailability of the first numerical quantity of DMRS symbols. In some examples, a deactivation message or command may indicate the position of the new or replacement symbols carrying DMRS REs or an offset for the replacement set of symbols carrying DMRS REs relative to the positions before deactivation.

FIG. 8 illustrates an example of a reference signal transmission diagram 800 in accordance with aspects of the present disclosure. In some examples, the reference signal transmission diagram 800 implements or is implemented by aspects of the wireless communications system 100, the resource diagram 200, the resource diagram 300, the resource diagram 400, the resource diagram 500, the resource diagram 600, and the reference signal transmission diagram 700. For example, the reference signal transmission diagram 800 may be implemented by one or more UEs and/or NEs, which may be an example of NEs 102 and UEs 104 as described with reference to FIG. 1. The reference signal transmission diagram 800 illustrates REG bundling and DMRS RE allocation across multiple carriers.

The reference signal transmission diagram 800 includes a carrier 802-a and a carrier 802-b, which may be examples of carriers that are non-contiguous in the frequency domain. The carrier 802-a and the carrier 802-b may include a grid of RBs spanning multiple symbols. The RBs may include resources without DMRS REs and resources with DMRS REs. In an initial configuration, both the carrier 802-a and the carrier 802-b include RBs without DMRS REs and with DMRS REs distributed across the symbols. The UE may receive signaling that deactivates the carrier 802-a. The UE may apply a modified DMRS pattern that replaces RBs without DMRS REs with RBs with DMRS REs in the carrier 802-b. The signaling indicating for the UE to deactivate the carrier 802-a may also indicate (e.g., via a parameter or field in the signaling) for the UE to apply the modified DMRS pattern. Additionally, or alternatively, the UE may determine to apply the modified DMRS pattern to ensure there are sufficient DMRS REs (e.g., greater than a threshold value) in the carrier 802-b.

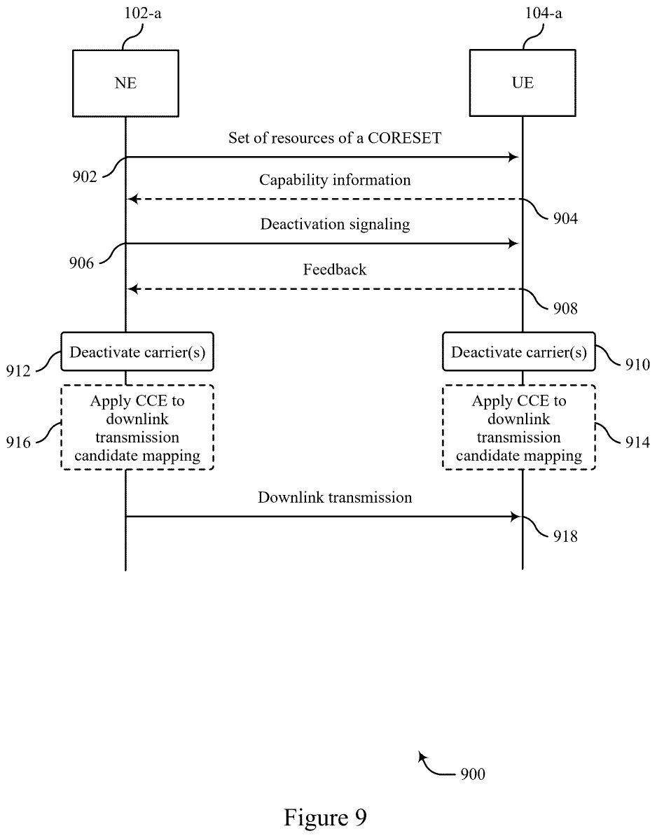

FIG. 9 illustrates an example of a signaling diagram 900 in accordance with aspects of the present disclosure. In some examples, the signaling diagram 900 implements or is implemented by aspects of the wireless communications system 100, the resource diagram 200, the resource diagram 300, the resource diagram 400, the resource diagram 500, the resource diagram 600, the reference signal transmission diagram 700, and the reference signal transmission diagram 800. The signaling diagram 900 may implement or be implemented by an NE 102-a and a UE 104-a, which may be examples of the corresponding devices as described with reference to FIG. 1. For example, the NE 102-a may provide the UE 104-a with a configuration for resources of a CORESET spanning multiple non-contiguous carriers and may transmit deactivation signaling to coordinate carrier deactivation. Alternative examples of the following may be implemented, where some processes are performed in a different order than described or are not performed. In some cases, processes may include additional features not mentioned below, or further processes may be added.

In some examples, the NE 102-a may be an example of a base station (e.g., gNB) or other network node. The UE 104-a may be an example of a mobile device, wireless device, or other UE configured to communicate with the NE 102-a.

At 902, the UE 104-a receives first signaling that indicates a set of resources of a CORESET from an NE 102-a. In some examples, the set of resources includes a set of CCEs, where a CCE includes a set of REG bundles, where a REG bundle includes a set of contiguous REGs, and where a REG includes a set of contiguous REs or subcarriers in a symbol. In some cases, the first signaling indicates a maximum numerical quantity of downlink transmission candidates to monitor within the CORESET, and the set of resources includes a set of CCEs. The maximum numerical quantity of downlink transmission candidates may be configured per aggregation level, such as 8 aggregation level 1 candidates, 4 aggregation level 2 candidates, and so on.

In some cases, at 904, the UE 104-a transmits capability information to the NE 102-a. The capability information may indicate a capability of the UE 104-a to jointly deactivate multiple carriers of a set of carriers. In some examples, the capability information may indicate a maximum counter value over a duration for deactivation and reactivation of respective carriers of the set of carriers. The capability information enables the NE 102-a to determine deactivation commands that do not exceed a processing capability of the UE 104-a. In some examples, the capability information may indicate a maximum number (e.g., numerical quantity, amount) of frequency segments (e.g., carriers) that the UE 104-a can deactivate with a single command, which may reduce signaling overhead and complexity at the UE 104-a.

At 906, the NE 102-a transmits deactivation signaling to the UE 104-a. The deactivation signaling indicates that at least one first carrier of the set of carriers is to be deactivated. The deactivation signaling may indicate whether the at least one first carrier is deactivated for at least one of a downlink transmission or a data transmission. In some examples, the deactivation signaling may be transmitted via a MAC-CE command or a DCI command (e.g., if the deactivation is within a BWP). In some examples, the deactivation signaling includes at least one parameter that indicates to apply a CCE to downlink transmission candidate mapping or an additional CCE to downlink transmission candidate mapping. In some examples, the deactivation signaling includes at least one parameter (e.g., field, indicator, flag) that indicates to apply a first CCE to REG mapping or a second CCE to REG mapping. The first CCE to REG mapping is an interleaved mapping, and the second CCE to REG mapping is a non-interleaved mapping. In some examples, if a frequency segment is deactivated and there was overlap between REG bundles or CCEs spanning multiple frequency segments, then the UE 104-a may autonomously switch to non-interleaved mode, where resources are contiguous within each remaining active carrier.

In some cases, at 908, the UE 104-a transmits feedback to the NE 102-a in response to the deactivation signaling. The feedback may be an example of an ACK for HARQ feedback, where the ACK confirms successful reception of the deactivation signaling. In some examples, the UE 104-a deactivates the at least one first carrier for a duration starting from a time offset with respect to at least one of reception of the deactivation signaling or transmission of the feedback, where at least one of the first signaling or the deactivation signaling indicates the duration. In some cases, the time offset may be zero, such that the UE 104-a deactivates the at least one first carrier for a duration starting from at least one of reception of the deactivation signaling or transmission of the feedback. The timeline for deactivation may be defined such that the command is sent early enough for the UE 104-a to have time to apply the command and perform processing, such as renumbering CCEs differently when a frequency segment is deactivated.

At 910, the UE 104-a performs a deactivation operation to deactivate the at least one first carrier. The UE 104-a may exclude the REG bundles and CCEs within the at least one first carrier from the set of resources used for control channel monitoring. In some examples, the deactivation may be for control channel monitoring purposes, where the UE 104-a avoids monitoring control channel candidates on the deactivated carrier to save power, while the UE 104-a may still be scheduled for data transmission within the deactivated carrier.

In some examples, at least one of first signaling that indicates a set of resources of the CORESET or the deactivation signaling indicates a timer. The UE 104-a activates the timer upon reception of the set of resources of the CORESET and/or deactivation signaling. The UE 104-a deactivates, upon expiry of the timer, the at least one first carrier. In some examples, at least one of the first signaling or the deactivation signaling indicates a duration, and the UE 104-a deactivates the at least one first carrier after the duration.

At 912, the NE 102-a deactivates the at least one first carrier. The NE 102-a may refrain from transmitting downlink transmissions on the at least one first carrier following the deactivation. The NE 102-a may determine to deactivate the at least one first carrier based on traffic load, channel conditions, or power saving criterion.

In some examples, at 914, the NE 102-a applies a CCE to downlink transmission candidate mapping in response to the deactivation. The NE 102-a may apply the CCE to downlink transmission candidate mapping in accordance with the deactivation signaling. In some examples, downlink transmission candidates for the downlink transmission are within respective carriers of the set of carriers according to the CCE to downlink transmission candidate mapping, where each PDCCH candidate is contained within a single frequency segment and does not span CCEs across multiple frequency segments. In some examples, downlink transmission candidates for the downlink transmission are distributed across the at least one second carrier according to the CCE to downlink transmission candidate mapping, where the distribution may be based on the number of available resources for control in each frequency segment using a weighted distribution.

At 916, the UE 104-a applies a CCE to downlink transmission candidate mapping to account for the deactivated carriers. In some examples, the UE 104-a determines the CCE to downlink transmission candidate mapping using a numerical quantity of available CCEs at a time deactivating the at least one first carrier. In some examples, to apply the CCE to downlink transmission candidate mapping, the UE 104-a maps downlink transmission candidates for the downlink transmission using the maximum numerical quantity of downlink transmission candidates and one or more available CCEs, where the subset of resources of the set of resources includes the one or more available CCEs. In some examples, to apply the CCE to downlink transmission candidate mapping, the UE 104-a discards one or more downlink transmission candidates of a set of downlink transmission candidates for the downlink transmission in response to the one or more downlink transmission candidates being within the at least one first carrier. In some examples, the UE 104-a may use an existing mapping rule and determine that PDCCH candidates mapped to invalid CCEs in the deactivated frequency segment are not considered for monitoring.

The UE 104-a may apply a CCE to REG mapping to receive the downlink transmission in accordance with the deactivation signaling. In some examples, the deactivation signaling may indicate different interleaving parameters for the CCE to REG mapping, or the MAC-CE command may indicate the exact mapping parameters to be used following deactivation. In some examples, the UE 104-a may define separate interleaved mappings for REGs within each remaining active frequency segment to maintain frequency diversity within each segment.

At 916, the NE 102-a applies the CCE to downlink transmission candidate mapping for a downlink transmissions. The NE 102-a may also apply a CCE to REG mapping in accordance with the deactivation signaling.

At 918, the NE 102-a transmits a downlink transmission to the UE 104-a during a subset of resources of the set of resources within at least one second carrier of the set of carriers. The at least one first carrier is different from the at least one second carrier. The UE 104-a receives the downlink transmission during the subset of resources within the at least one second carrier.

In some examples, the set of carriers are configured with a first DMRS pattern, and the UE 104-a applies, in accordance with the deactivation signaling, a second DMRS pattern to the at least one second carrier, where the first DMRS pattern is different from the second DMRS pattern. The second DMRS pattern may include one or more first DMRS REs within the subset of resources, and the second DMRS pattern may include one or more second DMRS REs different from the one or more first DMRS REs. The UE 104-a may decode the downlink transmission upon deactivating the at least one first carrier and using the second DMRS pattern. In some examples, when a frequency segment is deactivated, reference signal resources that may have been utilized for channel estimation are eliminated, and the UE 104-a may switch to having additional DMRS resources spread in the remaining active frequency segment to compensate for the lost reference signals. In some examples, the UE 104-a may switch back to a configuration where every symbol in the control channel includes DMRS resources, to provide channel estimation capability. The UE 104-a and the NE 102-a may utilize the additional reference resources in scenarios where signal-to-noise (SNR) operating regime is low (e.g., below a threshold value) to perform averaging and ensure signal quality is above a noise level. In some examples, the deactivation signaling may include a one-bit indication to switch to additional DMRS resources following deactivation.

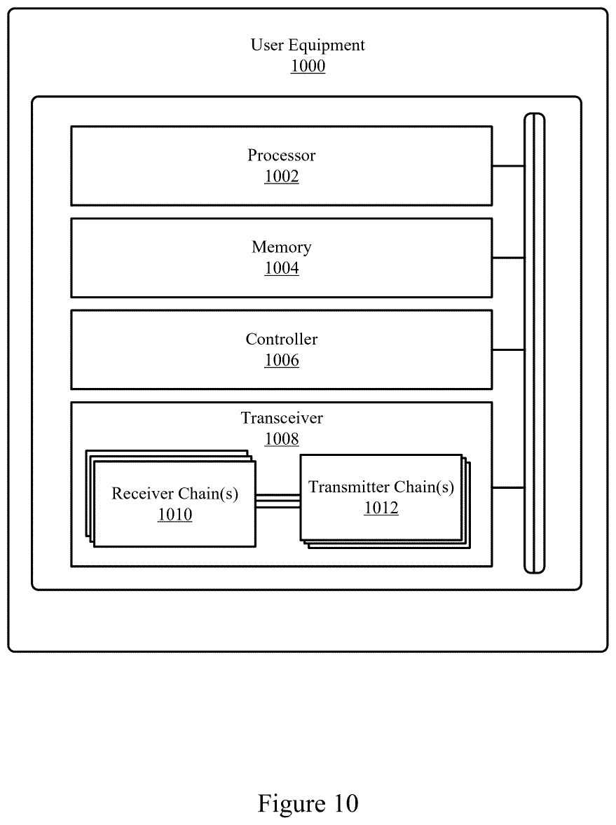

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a central processing unit (CPU), an ASIC, a field-programmable gate-array (FPGA), or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the functions described herein (e.g., executing, by the processor 1002, instructions stored in the memory 1004). For example, the processor 1002 may support wireless communication at the UE 1000 in accordance with examples as disclosed herein. The UE 1000 may be configured to or operable to support a means for receiving first signaling that indicates a set of resources of a CORESET associated with a downlink transmission, where the set of resources spans a set of carriers that are non-contiguous in a frequency domain, receiving second signaling that indicates to deactivate at least one first carrier of the set of carriers, and receiving the downlink transmission during a subset of resources of the set of resources associated with at least one second carrier of the set of carriers. In this manner, the UE 1000 achieves improved resource utilization and reduced power consumption by dynamically adjusting control channel monitoring based on carrier deactivation signaling, enabling the UE 1000 to focus processing resources on active carriers, while reducing monitoring of deactivated carriers.

Additionally, the UE 1000 may be configured to or operable to support any one or combination of at least one of the first signaling or the second signaling indicates a timer, and deactivating, based on expiry of the timer, the at least one first carrier. This aspect enables the UE 1000 to implement automatic carrier deactivation based on inactivity, reducing resource monitoring and improving power efficiency. Additionally, or alternatively, the UE 1000 may be configured to or operable to support transmitting feedback in response to the second signaling, and deactivating the at least one first carrier for a duration starting from a time offset with respect to at least one of reception of the second signaling or transmission of the feedback, where at least one of the first signaling or the second signaling indicates the duration. This aspect enables coordinated deactivation timing between the UE 1000 and NE, ensuring reliable transition to reduced carrier configurations, while maintaining communication continuity. Additionally, or alternatively, the UE 1000 may be configured to or operable to support deactivating the at least one first carrier after a duration, where at least one of the first signaling or the second signaling indicates the duration. This aspect enables predictable deactivation scheduling, providing sufficient time to adjust resource mappings and receiver chain configurations. Additionally, or alternatively, the UE 1000 may be configured to or operable to support transmitting third signaling that indicates a capability of the UE to jointly deactivate multiple carriers of the set of carriers, where the at least one first carrier includes the multiple carriers based on the capability. This aspect enables the UE 1000 to communicate processing capabilities to an NE, providing for improved deactivation commands that reduce signaling overhead. Additionally, or alternatively, the UE 1000 may be configured to or operable to support transmitting third signaling that indicates a maximum counter value over a duration associated with deactivation and reactivation of respective carriers of the set of carriers. This aspect enables the UE 1000 to manage deactivation and reactivation frequency within processing capabilities, preventing excessive reconfiguration overhead.

Additionally, or alternatively, the UE 1000 may be configured to or operable to support the first signaling indicates a maximum numerical quantity of downlink transmission candidates to monitor within the CORESET, where the set of resources includes a set of CCEs, and where to receive the downlink transmission, the UE 1000 may be configured to or operable to support applying, based on the second signaling, a CCE to downlink transmission candidate mapping. This aspect enables the UE 1000 to maintain efficient PDCCH candidate distribution across active carriers following deactivation, improving spectral efficiency and decoding reliability. Additionally, or alternatively, the UE 1000 may be configured to or operable to support the second signaling includes at least one parameter that indicates to apply the CCE to downlink transmission candidate mapping or an additional CCE to downlink transmission candidate mapping. This aspect enables flexible mapping selection based on carrier deactivation scenarios, supporting diverse deployment configurations. Additionally, or alternatively, the UE 1000 may be configured to or operable to support determining the CCE to downlink transmission candidate mapping based on a numerical quantity of available CCEs at a time deactivating the at least one first carrier. This aspect enables adaptive resource mapping that accounts for the reduced set of available CCEs following carrier deactivation. Additionally, or alternatively, the UE 1000 may be configured to or operable to support downlink transmission candidates associated with the downlink transmission are within respective carriers of the set of carriers based on the CCE to downlink transmission candidate mapping. This aspect enables localized candidate placement within individual carriers, simplifying monitoring and reducing cross-carrier processing complexity. Additionally, or alternatively, the UE 1000 may be configured to or operable to support downlink transmission candidates associated with the downlink transmission are distributed across the at least one second carrier based on the CCE to downlink transmission candidate mapping. This aspect enables frequency diversity across active carriers, improving decoding reliability under varying channel conditions. Additionally, or alternatively, to apply the CCE to downlink transmission candidate mapping, the UE 1000 may be configured to or operable to support mapping downlink transmission candidates associated with the downlink transmission based on the maximum numerical quantity of downlink transmission candidates and one or more available CCEs, where the subset of resources of the set of resources includes the one or more available CCEs. This aspect enables efficient candidate mapping that utilizes available resources, while respecting configured monitoring limits. Additionally, or alternatively, to apply the CCE to downlink transmission candidate mapping, the UE 1000 may be configured to or operable to support discarding one or more downlink transmission candidates of a set of downlink transmission candidates associated with the downlink transmission based on the one or more downlink transmission candidates being associated with the at least one first carrier. This aspect enables the UE 1000 to exclude candidates mapped to deactivated carriers, reducing decoding attempts and conserving processing resources.

Additionally, or alternatively, the UE 1000 may be configured to or operable to support the set of resources includes a set of CCEs, where a CCE includes a set of REG bundles, where a REG bundle includes a set of contiguous REGs, and where a REG includes a set of contiguous REs or subcarriers in a symbol, and where to receive the downlink transmission, the UE 1000 may be configured to or operable to support applying, based on the second signaling, a CCE to REG mapping. This aspect enables adaptive RE allocation following carrier deactivation, maintaining efficient control channel reception on remaining active carriers. Additionally, or alternatively, the UE 1000 may be configured to or operable to support the second signaling includes at least one parameter that indicates to apply a first CCE to REG mapping or a second CCE to REG mapping. This aspect enables dynamic selection between interleaved and non-interleaved mappings based on active carrier configurations, improving frequency diversity or localization. Additionally, or alternatively, the UE 1000 may be configured to or operable to support the first CCE to REG mapping is an interleaved mapping and the second CCE to REG mapping is a non-interleaved mapping. This aspect enables the UE 1000 to switch between mapping types to accommodate reduced carrier configurations, while maintaining decoding performance. Additionally, or alternatively, the UE 1000 may be configured to or operable to support the second signaling indicates that the at least one first carrier is deactivated for at least one of the downlink transmission or a data transmission. This aspect enables selective deactivation for control or data purposes, providing flexibility for power saving, while maintaining communication capabilities.

Additionally, or alternatively, the UE 1000 may be configured to or operable to support the set of carriers are associated with a first DMRS pattern, and applying, based on the second signaling, a second DMRS pattern to the at least one second carrier, where the first DMRS pattern is different from the second DMRS pattern. This aspect enables adaptive reference signal configuration following carrier deactivation, maintaining channel estimation accuracy on active carriers. Additionally, or alternatively, the UE 1000 may be configured to or operable to support decoding, based on deactivating the at least one first carrier and using the second DMRS pattern, the downlink transmission. This aspect enables reliable decoding of downlink transmissions using modified reference signal patterns that compensate for reduced frequency diversity. Additionally, or alternatively, the UE 1000 may be configured to or operable to support the second DMRS pattern includes one or more first DMRS REs associated with the subset of resources, and the second DMRS pattern includes one or more second DMRS REs different from the one or more first DMRS REs. This aspect enables enhanced reference signal density on remaining active carriers, compensating for reduced frequency diversity and improving decoding reliability.

Additionally, or alternatively, the UE 1000 may support at least one memory (e.g., the memory 1004) and at least one processor (e.g., the processor 1002) coupled with the at least one memory and configured to cause the UE to receive first signaling that indicates a set of resources of a CORESET associated with a downlink transmission, where the set of resources spans a set of carriers that are non-contiguous in a frequency domain, receive second signaling that indicates to deactivate at least one first carrier of the set of carriers, and receive the downlink transmission during a subset of resources of the set of resources associated with at least one second carrier of the set of carriers.

Additionally, the UE 1000 may be configured to or operable to support any one or combination of at least one of the first signaling or the second signaling indicates a timer, and to deactivate, based on expiry of the timer, the at least one first carrier. Additionally, or alternatively, the UE 1000 may be configured to or operable to support to transmit feedback in response to the second signaling, and deactivate the at least one first carrier for a duration starting from a time offset with respect to at least one of reception of the second signaling or transmission of the feedback, where at least one of the first signaling or the second signaling indicates the duration. Additionally, or alternatively, the UE 1000 may be configured to or operable to support to deactivate the at least one first carrier after a duration, where at least one of the first signaling or the second signaling indicates the duration. Additionally, or alternatively, the UE 1000 may be configured to or operable to support to transmit third signaling that indicates a capability of the UE to jointly deactivate multiple carriers of the set of carriers, where the at least one first carrier includes the multiple carriers based on the capability. Additionally, or alternatively, the UE 1000 may be configured to or operable to support to transmit third signaling that indicates a maximum counter value over a duration associated with deactivation and reactivation of respective carriers of the set of carriers.

Additionally, or alternatively, the UE 1000 may be configured to or operable to support the first signaling indicates a maximum numerical quantity of downlink transmission candidates to monitor within the CORESET, where the set of resources includes a set of CCEs, and where to receive the downlink transmission, the UE 1000 may be configured to or operable to support to apply, based on the second signaling, a CCE to downlink transmission candidate mapping. Additionally, or alternatively, the UE 1000 may be configured to or operable to support the second signaling includes at least one parameter that indicates to apply the CCE to downlink transmission candidate mapping or an additional CCE to downlink transmission candidate mapping.

Additionally, or alternatively, the UE 1000 may be configured to or operable to support to determine the CCE to downlink transmission candidate mapping based on a numerical quantity of available CCEs at a time deactivating the at least one first carrier. Additionally, or alternatively, the UE 1000 may be configured to or operable to support downlink transmission candidates associated with the downlink transmission are within respective carriers of the set of carriers based on the CCE to downlink transmission candidate mapping. Additionally, or alternatively, the UE 1000 may be configured to or operable to support downlink transmission candidates associated with the downlink transmission are distributed across the at least one second carrier based on the CCE to downlink transmission candidate mapping. Additionally, or alternatively, to apply the CCE to downlink transmission candidate mapping, the UE 1000 may be configured to or operable to support to map downlink transmission candidates associated with the downlink transmission based on the maximum numerical quantity of downlink transmission candidates and one or more available CCEs, where the subset of resources of the set of resources includes the one or more available CCEs. Additionally, or alternatively, to apply the CCE to downlink transmission candidate mapping, the UE 1000 may be configured to or operable to support to discard one or more downlink transmission candidates of a set of downlink transmission candidates associated with the downlink transmission based on the one or more downlink transmission candidates being associated with the at least one first carrier.

Additionally, or alternatively, the UE 1000 may be configured to or operable to support the set of resources includes a set of CCEs, where a CCE includes a set of REG bundles, where a REG bundle includes a set of contiguous REGs, and where a REG includes a set of contiguous REs or subcarriers in a symbol, and where to receive the downlink transmission, the UE 1000 may be configured to or operable to support to apply, based on the second signaling, a CCE to REG mapping. Additionally, or alternatively, the UE 1000 may be configured to or operable to support the second signaling includes at least one parameter that indicates to apply a first CCE to REG mapping or a second CCE to REG mapping. Additionally, or alternatively, the UE 1000 may be configured to or operable to support the first CCE to REG mapping is an interleaved mapping and the second CCE to REG mapping is a non-interleaved mapping. Additionally, or alternatively, the UE 1000 may be configured to or operable to support the second signaling indicates that the at least one first carrier is deactivated for at least one of the downlink transmission or a data transmission. Additionally, or alternatively, the UE 1000 may be configured to or operable to support the set of carriers are associated with a first DMRS pattern, and to apply, based on the second signaling, a second DMRS pattern to the at least one second carrier, where the first DMRS pattern is different from the second DMRS pattern. Additionally, or alternatively, the UE 1000 may be configured to or operable to support to decode, based on deactivating the at least one first carrier and using the second DMRS pattern, the downlink transmission. Additionally, or alternatively, the UE 1000 may be configured to or operable to support the second DMRS pattern includes one or more first DMRS REs associated with the subset of resources, and the second DMRS pattern includes one or more second DMRS REs different from the one or more first DMRS REs.

The controller 1006 may manage input and output signals for the UE 1000. The controller 1006 may also manage peripherals not integrated into the UE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

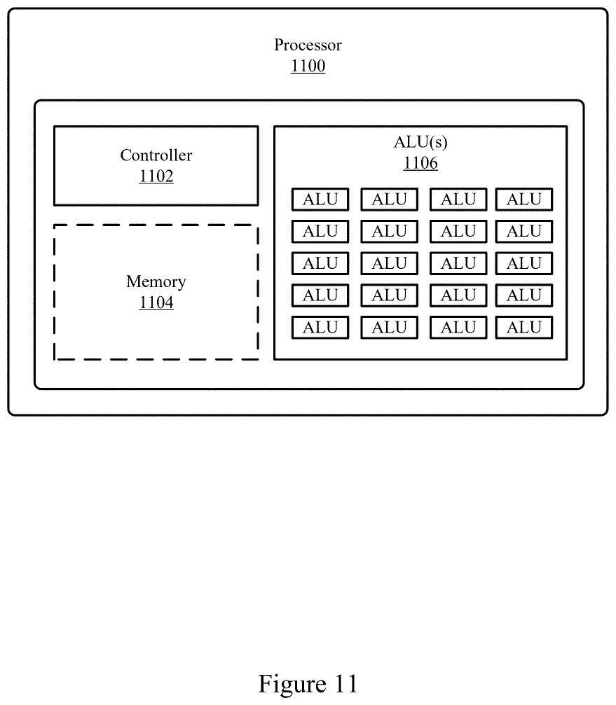

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory addresses of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, ALUs 1106, and other functional units of the processor 1100.

The memory 1104 may include one or more caches (e.g., memory local to or included in the processor 1100 or other memory, such as RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, and the controller 1102, and may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 may be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to receive first signaling that indicates a set of resources of a CORESET associated with a downlink transmission, where the set of resources spans a set of carriers that are non-contiguous in a frequency domain, receive second signaling that indicates to deactivate at least one first carrier of the set of carriers, and receive the downlink transmission during a subset of resources of the set of resources associated with at least one second carrier of the set of carriers. In this manner, the processor 1100 achieves improved resource utilization and reduced power consumption by dynamically adjusting control channel monitoring based on carrier deactivation signaling, enabling the processor 1100 to focus processing resources on active carriers, while reducing monitoring of deactivated carriers.

Additionally, the processor 1100 may be configured to or operable to support any one or combination of at least one of the first signaling or the second signaling indicates a timer, and deactivating, based on expiry of the timer, the at least one first carrier. This aspect enables the processor 1100 to implement automatic carrier deactivation based on inactivity, reducing resource monitoring and improving power efficiency. Additionally, or alternatively, the processor 1100 may be configured to or operable to support transmitting feedback in response to the second signaling, and deactivating the at least one first carrier for a duration starting from a time offset with respect to at least one of reception of the second signaling or transmission of the feedback, where at least one of the first signaling or the second signaling indicates the duration. This aspect enables coordinated deactivation timing between the processor 1100 and NE, ensuring reliable transition to reduced carrier configurations, while maintaining communication continuity. Additionally, or alternatively, the processor 1100 may be configured to or operable to support deactivating the at least one first carrier after a duration, where at least one of the first signaling or the second signaling indicates the duration. This aspect enables predictable deactivation scheduling, providing sufficient time to adjust resource mappings and receiver chain configurations. Additionally, or alternatively, the processor 1100 may be configured to or operable to support transmitting third signaling that indicates a capability of a UE to jointly deactivate multiple carriers of the set of carriers, where the at least one first carrier includes the multiple carriers based on the capability. This aspect enables the processor 1100 to communicate processing capabilities to an NE, providing for improved deactivation commands that reduce signaling overhead. Additionally, or alternatively, the processor 1100 may be configured to or operable to support transmitting third signaling that indicates a maximum counter value over a duration associated with deactivation and reactivation of respective carriers of the set of carriers. This aspect enables the processor 1100 to manage deactivation and reactivation frequency within processing capabilities, preventing excessive reconfiguration overhead.

Additionally, or alternatively, the processor 1100 may be configured to or operable to support the first signaling indicates a maximum numerical quantity of downlink transmission candidates to monitor within the CORESET, where the set of resources includes a set of CCEs, and where to receive the downlink transmission, the processor 1100 may be configured to or operable to support applying, based on the second signaling, a CCE to downlink transmission candidate mapping. This aspect enables the processor 1100 to maintain efficient PDCCH candidate distribution across active carriers following deactivation, improving spectral efficiency and decoding reliability. Additionally, or alternatively, the processor 1100 may be configured to or operable to support the second signaling includes at least one parameter that indicates to apply the CCE to downlink transmission candidate mapping or an additional CCE to downlink transmission candidate mapping. This aspect enables flexible mapping selection based on carrier deactivation scenarios, supporting diverse deployment configurations. Additionally, or alternatively, the processor 1100 may be configured to or operable to support determining the CCE to downlink transmission candidate mapping based on a numerical quantity of available CCEs at a time deactivating the at least one first carrier. This aspect enables adaptive resource mapping that accounts for the reduced set of available CCEs following carrier deactivation. Additionally, or alternatively, the processor 1100 may be configured to or operable to support downlink transmission candidates associated with the downlink transmission are within respective carriers of the set of carriers based on the CCE to downlink transmission candidate mapping. This aspect enables localized candidate placement within individual carriers, simplifying monitoring and reducing cross-carrier processing complexity. Additionally, or alternatively, the processor 1100 may be configured to or operable to support downlink transmission candidates associated with the downlink transmission are distributed across the at least one second carrier based on the CCE to downlink transmission candidate mapping. This aspect enables frequency diversity across active carriers, improving decoding reliability under varying channel conditions. Additionally, or alternatively, to apply the CCE to downlink transmission candidate mapping, the processor 1100 may be configured to or operable to support mapping downlink transmission candidates associated with the downlink transmission based on the maximum numerical quantity of downlink transmission candidates and one or more available CCEs, where the subset of resources of the set of resources includes the one or more available CCEs. This aspect enables efficient candidate mapping that utilizes available resources while respecting configured monitoring limits. Additionally, or alternatively, to apply the CCE to downlink transmission candidate mapping, the processor 1100 may be configured to or operable to support discarding one or more downlink transmission candidates of a set of downlink transmission candidates associated with the downlink transmission based on the one or more downlink transmission candidates being associated with the at least one first carrier. This aspect enables the processor 1100 to exclude candidates mapped to deactivated carriers, reducing decoding attempts and conserving processing resources.

Additionally, or alternatively, the processor 1100 may be configured to or operable to support the set of resources includes a set of CCEs, where a CCE includes a set of REG bundles, where a REG bundle includes a set of contiguous REGs, and where a REG includes a set of contiguous REs or subcarriers in a symbol, and where to receive the downlink transmission, the processor 1100 may be configured to or operable to support applying, based on the second signaling, a CCE to REG mapping. This aspect enables adaptive RE allocation following carrier deactivation, maintaining efficient control channel reception on remaining active carriers. Additionally, or alternatively, the processor 1100 may be configured to or operable to support the second signaling includes at least one parameter that indicates to apply a first CCE to REG mapping or a second CCE to REG mapping. This aspect enables dynamic selection between interleaved and non-interleaved mappings based on active carrier configurations, improving frequency diversity or localization. Additionally, or alternatively, the processor 1100 may be configured to or operable to support the first CCE to REG mapping is an interleaved mapping and the second CCE to REG mapping is a non-interleaved mapping. This aspect enables the processor 1100 to switch between mapping types to accommodate reduced carrier configurations, while maintaining decoding performance. Additionally, or alternatively, the processor 1100 may be configured to or operable to support the second signaling indicates that the at least one first carrier is deactivated for at least one of the downlink transmission or a data transmission. This aspect enables selective deactivation for control or data purposes, providing flexibility for power saving, while maintaining communication capabilities. Additionally, or alternatively, the processor 1100 may be configured to or operable to support the set of carriers are associated with a first DMRS pattern, and applying, based on the second signaling, a second DMRS pattern to the at least one second carrier, where the first DMRS pattern is different from the second DMRS pattern. This aspect enables adaptive reference signal configuration following carrier deactivation, maintaining channel estimation accuracy on active carriers. Additionally, or alternatively, the processor 1100 may be configured to or operable to support decoding, based on deactivating the at least one first carrier and using the second DMRS pattern, the downlink transmission. This aspect enables reliable decoding of downlink transmissions using modified reference signal patterns that compensate for reduced frequency diversity. Additionally, or alternatively, the processor 1100 may be configured to or operable to support the second DMRS pattern includes one or more first DMRS REs associated with the subset of resources, and the second DMRS pattern includes one or more second DMRS REs different from the one or more first DMRS REs. This aspect enables enhanced reference signal density on remaining active carriers, compensating for reduced frequency diversity and improving decoding reliability.

The processor 1100 may be configured to or operable to support at least one controller (e.g., the controller 1102) coupled with at least one memory (e.g., the memory 1104) and configured to cause the processor to transmit first signaling that indicates a set of resources of a CORESET associated with a downlink transmission, where the set of resources spans a set of carriers that are non-contiguous in a frequency domain, transmit second signaling that indicates deactivation of at least one first carrier of the set of carriers, and transmit the downlink transmission during a subset of resources of the set of resources associated with at least one second carrier of the set of carriers, where the at least one first carrier is different from the at least one second carrier. In this manner, the processor 1100 achieves improved resource utilization and reduced signaling overhead by dynamically configuring CORESET resources across multiple non-contiguous carriers and selectively deactivating carriers based on traffic conditions, enabling the processor 1100 to support efficient spectrum aggregation, while reducing power consumption at UEs through focused monitoring on active carriers.

Additionally, the processor 1100 may be configured to or operable to support any one or combination of at least one of the first signaling or the second signaling indicates a timer, and deactivating, based on expiry of the timer, the at least one first carrier. This aspect enables the processor 1100 to implement automatic carrier deactivation based on inactivity, reducing resource monitoring and improving power efficiency at UEs. Additionally, or alternatively, the processor 1100 may be configured to or operable to support receiving feedback in response to the second signaling, and deactivating the at least one first carrier for a duration starting from a time offset with respect to at least one of transmission of the second signaling or reception of the feedback, where at least one of the first signaling or the second signaling indicates the duration. This aspect enables coordinated deactivation timing between the processor 1100 and UEs, ensuring reliable transition to reduced carrier configurations, while maintaining communication continuity. Additionally, or alternatively, the processor 1100 may be configured to or operable to support deactivating the at least one first carrier after a duration, where at least one of the first signaling or the second signaling indicates the duration. This aspect enables predictable deactivation scheduling, providing UEs sufficient time to adjust resource mappings and receiver chain configurations. Additionally, or alternatively, the processor 1100 may be configured to or operable to support receiving third signaling that indicates a capability of a UE to jointly deactivate multiple carriers of the set of carriers, where the at least one first carrier includes the multiple carriers based on the capability. This aspect enables the processor 1100 to optimize deactivation commands based on UE capabilities, reducing signaling overhead by consolidating multiple carrier deactivations into single commands. Additionally, or alternatively, the processor 1100 may be configured to or operable to support receiving third signaling that indicates a maximum counter value over a duration associated with deactivation and reactivation of respective carriers of the set of carriers. This aspect enables the processor 1100 to manage deactivation and reactivation frequency within UE processing capabilities, preventing excessive reconfiguration overhead.

Additionally, or alternatively, the processor 1100 may be configured to or operable to support the first signaling indicates a maximum numerical quantity of downlink transmission candidates within the CORESET, where the set of resources includes a set of CCEs, and where to transmit the downlink transmission, the processor 1100 may be configured to or operable to support applying, based on the second signaling, a CCE to downlink transmission candidate mapping. This aspect enables the processor 1100 to maintain efficient PDCCH candidate distribution across active carriers following deactivation, improving spectral efficiency and decoding reliability. Additionally, or alternatively, the processor 1100 may be configured to or operable to support the second signaling includes at least one parameter that indicates to apply the CCE to downlink transmission candidate mapping or an additional CCE to downlink transmission candidate mapping. This aspect enables flexible mapping selection based on carrier deactivation scenarios, supporting diverse deployment configurations. Additionally, or alternatively, the processor 1100 may be configured to or operable to support downlink transmission candidates associated with the downlink transmission are within respective carriers of the set of carriers based on the CCE to downlink transmission candidate mapping. This aspect enables localized candidate placement within individual carriers, simplifying UE monitoring and reducing cross-carrier processing complexity. Additionally, or alternatively, the processor 1100 may be configured to or operable to support downlink transmission candidates associated with the downlink transmission are distributed across the at least one second carrier based on the CCE to downlink transmission candidate mapping. This aspect enables frequency diversity across active carriers, improving decoding reliability under varying channel conditions.

Additionally, or alternatively, the processor 1100 may be configured to or operable to support the set of resources includes a set of CCEs, where a CCE includes a set of REG bundles, where a REG bundle includes a set of contiguous REGs, and where a REG includes a set of contiguous REs or subcarriers in a symbol, and where to transmit the downlink transmission, the processor 1100 may be configured to or operable to support applying, based on the second signaling, a CCE to REG mapping. This aspect enables adaptive RE allocation following carrier deactivation, maintaining efficient control channel transmission on remaining active carriers. Additionally, or alternatively, the processor 1100 may be configured to or operable to support the second signaling includes at least one parameter that indicates to apply a first CCE to REG mapping or a second CCE to REG mapping. This aspect enables dynamic selection between interleaved and non-interleaved mappings based on active carrier configurations, improving frequency diversity or localization. Additionally, or alternatively, the processor 1100 may be configured to or operable to support the first CCE to REG mapping is an interleaved mapping and the second CCE to REG mapping is a non-interleaved mapping. This aspect enables the processor 1100 to switch between mapping types to accommodate reduced carrier configurations, while maintaining decoding performance. Additionally, or alternatively, the processor 1100 may be configured to or operable to support the second signaling indicates that the at least one first carrier is deactivated for at least one of the downlink transmission or a data transmission. This aspect enables selective deactivation for control or data purposes, providing flexibility for power saving, while maintaining communication capabilities. Additionally, or alternatively, the processor 1100 may be configured to or operable to support the set of carriers are associated with a first DMRS pattern, and applying, based on the second signaling, a second DMRS pattern to the at least one second carrier, where the first DMRS pattern is different from the second DMRS pattern. This aspect enables adaptive reference signal configuration following carrier deactivation, maintaining channel estimation accuracy on active carriers. Additionally, or alternatively, the processor 1100 may be configured to or operable to support the second DMRS pattern includes one or more first DMRS REs associated with the subset of resources, and the second DMRS pattern includes one or more second DMRS REs different from the one or more first DMRS REs. This aspect enables enhanced reference signal density on remaining active carriers, compensating for reduced frequency diversity and improving decoding reliability.

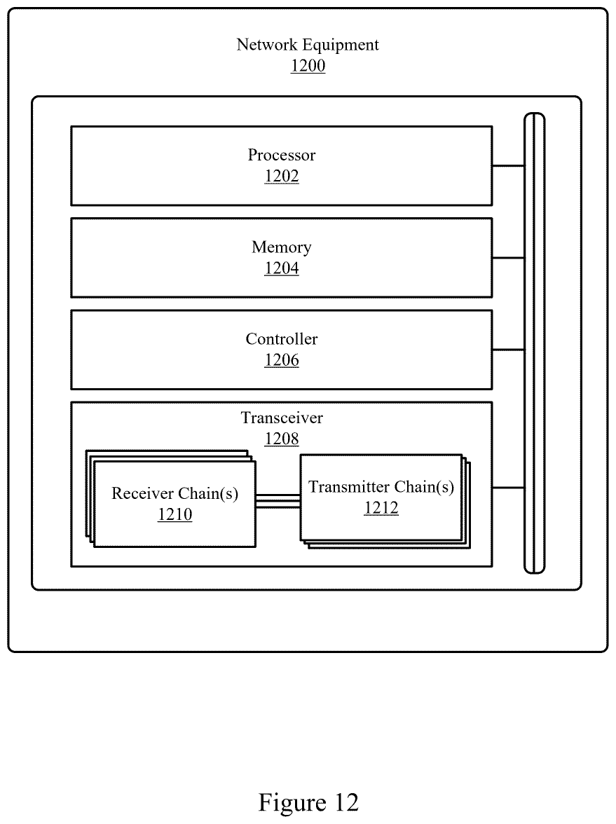

FIG. 12 illustrates an example of an NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204).

For example, the processor 1202 may support wireless communication at the NE 1200 in accordance with examples as disclosed herein. The NE 1200 may be configured to or operable to support a means for transmitting first signaling that indicates a set of resources of a CORESET associated with a downlink transmission, where the set of resources spans a set of carriers that are non-contiguous in a frequency domain, transmitting second signaling that indicates deactivation of at least one first carrier of the set of carriers, and transmitting the downlink transmission during a subset of resources of the set of resources associated with at least one second carrier of the set of carriers, where the at least one first carrier is different from the at least one second carrier. In this manner, the NE 1200 achieves improved resource utilization and reduced signaling overhead by dynamically configuring CORESET resources across multiple non-contiguous carriers and selectively deactivating carriers based on traffic conditions, enabling the NE 1200 to support efficient spectrum aggregation, while reducing power consumption at UEs through focused monitoring on active carriers.

Additionally, the NE 1200 may be configured to or operable to support any one or combination of at least one of the first signaling or the second signaling indicates a timer, and deactivating, based on expiry of the timer, the at least one first carrier. This aspect enables the NE 1200 to implement automatic carrier deactivation based on inactivity, reducing resource monitoring and improving power efficiency at UEs. Additionally, or alternatively, the NE 1200 may be configured to or operable to support receiving feedback in response to the second signaling, and deactivating the at least one first carrier for a duration starting from a time offset with respect to at least one of transmission of the second signaling or reception of the feedback, where at least one of the first signaling or the second signaling indicates the duration. This aspect enables coordinated deactivation timing between the NE 1200 and UEs, ensuring reliable transition to reduced carrier configurations, while maintaining communication continuity. Additionally, or alternatively, the NE 1200 may be configured to or operable to support deactivating the at least one first carrier after a duration, where at least one of the first signaling or the second signaling indicates the duration. This aspect enables predictable deactivation scheduling, providing UEs sufficient time to adjust resource mappings and receiver chain configurations. Additionally, or alternatively, the NE 1200 may be configured to or operable to support receiving third signaling that indicates a capability of a UE to jointly deactivate multiple carriers of the set of carriers, where the at least one first carrier includes the multiple carriers based on the capability. This aspect enables the NE 1200 to optimize deactivation commands based on UE capabilities, reducing signaling overhead by consolidating multiple carrier deactivations into single commands. Additionally, or alternatively, the NE 1200 may be configured to or operable to support receiving third signaling that indicates a maximum counter value over a duration associated with deactivation and reactivation of respective carriers of the set of carriers. This aspect enables the NE 1200 to manage deactivation and reactivation frequency within UE processing capabilities, preventing excessive reconfiguration overhead.

Additionally, or alternatively, the NE 1200 may be configured to or operable to support the first signaling indicates a maximum numerical quantity of downlink transmission candidates within the CORESET, where the set of resources includes a set of CCEs, and where to transmit the downlink transmission, the NE 1200 may be configured to or operable to support applying, based on the second signaling, a CCE to downlink transmission candidate mapping. This aspect enables the NE 1200 to maintain efficient PDCCH candidate distribution across active carriers following deactivation, improving spectral efficiency and decoding reliability. Additionally, or alternatively, the NE 1200 may be configured to or operable to support the second signaling includes at least one parameter that indicates to apply the CCE to downlink transmission candidate mapping or an additional CCE to downlink transmission candidate mapping. This aspect enables flexible mapping selection based on carrier deactivation scenarios, supporting diverse deployment configurations. Additionally, or alternatively, the NE 1200 may be configured to or operable to support downlink transmission candidates associated with the downlink transmission are within respective carriers of the set of carriers based on the CCE to downlink transmission candidate mapping. This aspect enables localized candidate placement within individual carriers, simplifying UE monitoring and reducing cross-carrier processing complexity. Additionally, or alternatively, the NE 1200 may be configured to or operable to support downlink transmission candidates associated with the downlink transmission are distributed across the at least one second carrier based on the CCE to downlink transmission candidate mapping. This aspect enables frequency diversity across active carriers, improving decoding reliability under varying channel conditions.

Additionally, or alternatively, the NE 1200 may be configured to or operable to support the set of resources includes a set of CCEs, where a CCE includes a set of REG bundles, where a REG bundle includes a set of contiguous REGs, and where a REG includes a set of contiguous REs or subcarriers in a symbol, and where to transmit the downlink transmission, the NE 1200 may be configured to or operable to support applying, based on the second signaling, a CCE to REG mapping. This aspect enables adaptive RE allocation following carrier deactivation, maintaining efficient control channel transmission on remaining active carriers. Additionally, or alternatively, the NE 1200 may be configured to or operable to support the second signaling includes at least one parameter that indicates to apply a first CCE to REG mapping or a second CCE to REG mapping. This aspect enables dynamic selection between interleaved and non-interleaved mappings based on active carrier configurations, improving frequency diversity or localization. Additionally, or alternatively, the NE 1200 may be configured to or operable to support the first CCE to REG mapping is an interleaved mapping and the second CCE to REG mapping is a non-interleaved mapping. This aspect enables the NE 1200 to switch between mapping types to accommodate reduced carrier configurations, while maintaining decoding performance. Additionally, or alternatively, the NE 1200 may be configured to or operable to support the second signaling indicates that the at least one first carrier is deactivated for at least one of the downlink transmission or a data transmission. This aspect enables selective deactivation for control or data purposes, providing flexibility for power saving, while maintaining communication capabilities. Additionally, or alternatively, the NE 1200 may be configured to or operable to support the set of carriers are associated with a first DMRS pattern, and applying, based on the second signaling, a second DMRS pattern to the at least one second carrier, where the first DMRS pattern is different from the second DMRS pattern. This aspect enables adaptive reference signal configuration following carrier deactivation, maintaining channel estimation accuracy on active carriers. Additionally, or alternatively, the NE 1200 may be configured to or operable to support the second DMRS pattern includes one or more first DMRS REs associated with the subset of resources, and the second DMRS pattern includes one or more second DMRS REs different from the one or more first DMRS REs. This aspect enables enhanced reference signal density on remaining active carriers, compensating for reduced frequency diversity and improving decoding reliability.

Additionally, or alternatively, the NE 1200 may support at least one memory (e.g., the memory 1204) and at least one processor (e.g., the processor 1202) coupled with the at least one memory and configured to cause the NE to transmit first signaling that indicates a set of resources of a CORESET associated with a downlink transmission, where the set of resources spans a set of carriers that are non-contiguous in a frequency domain, transmit second signaling that indicates deactivation of at least one first carrier of the set of carriers, and transmit the downlink transmission during a subset of resources of the set of resources associated with at least one second carrier of the set of carriers, where the at least one first carrier is different from the at least one second carrier.

Additionally, the NE 1200 may be configured to support any one or combination of at least one of the first signaling or the second signaling indicates a timer, and to deactivate, based on expiry of the timer, the at least one first carrier. Additionally, or alternatively, the NE 1200 may be configured to or operable to support to receive feedback in response to the second signaling, and deactivate the at least one first carrier for a duration starting from a time offset with respect to at least one of transmission of the second signaling or reception of the feedback, where at least one of the first signaling or the second signaling indicates the duration. Additionally, or alternatively, the NE 1200 may be configured to or operable to support to deactivate the at least one first carrier after a duration, where at least one of the first signaling or the second signaling indicates the duration. Additionally, or alternatively, the NE 1200 may be configured to or operable to support to receive third signaling that indicates a capability of a UE to jointly deactivate multiple carriers of the set of carriers, where the at least one first carrier includes the multiple carriers based on the capability. Additionally, or alternatively, the NE 1200 may be configured to or operable to support to receive third signaling that indicates a maximum counter value over a duration associated with deactivation and reactivation of respective carriers of the set of carriers.

Additionally, or alternatively, the NE 1200 may be configured to or operable to support the first signaling indicates a maximum numerical quantity of downlink transmission candidates within the CORESET, where the set of resources includes a set of CCEs, and where to transmit the downlink transmission, the NE 1200 may be configured to or operable to support to apply, based on the second signaling, a CCE to downlink transmission candidate mapping. Additionally, or alternatively, the NE 1200 may be configured to or operable to support the second signaling includes at least one parameter that indicates to apply the CCE to downlink transmission candidate mapping or an additional CCE to downlink transmission candidate mapping. Additionally, or alternatively, the NE 1200 may be configured to or operable to support downlink transmission candidates associated with the downlink transmission are within respective carriers of the set of carriers based on the CCE to downlink transmission candidate mapping. Additionally, or alternatively, the NE 1200 may be configured to or operable to support downlink transmission candidates associated with the downlink transmission are distributed across the at least one second carrier based on the CCE to downlink transmission candidate mapping.

Additionally, or alternatively, the NE 1200 may be configured to or operable to support the set of resources includes a set of CCEs, where a CCE includes a set of REG bundles, where a REG bundle includes a set of contiguous REGs, and where a REG includes a set of contiguous REs or subcarriers in a symbol, and where to transmit the downlink transmission, the NE 1200 may be configured to or operable to support to apply, based on the second signaling, a CCE to REG mapping. Additionally, or alternatively, the NE 1200 may be configured to or operable to support the second signaling includes at least one parameter that indicates to apply a first CCE to REG mapping or a second CCE to REG mapping. Additionally, or alternatively, the NE 1200 may be configured to or operable to support the first CCE to REG mapping is an interleaved mapping and the second CCE to REG mapping is a non-interleaved mapping. Additionally, or alternatively, the NE 1200 may be configured to or operable to support the second signaling indicates that the at least one first carrier is deactivated for at least one of the downlink transmission or a data transmission. Additionally, or alternatively, the NE 1200 may be configured to or operable to support the set of carriers are associated with a first DMRS pattern, and to apply, based on the second signaling, a second DMRS pattern to the at least one second carrier, where the first DMRS pattern is different from the second DMRS pattern. Additionally, or alternatively, the NE 1200 may be configured to or operable to support the second DMRS pattern includes one or more first DMRS REs associated with the subset of resources, and the second DMRS pattern includes one or more second DMRS REs different from the one or more first DMRS REs.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., an LNA) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

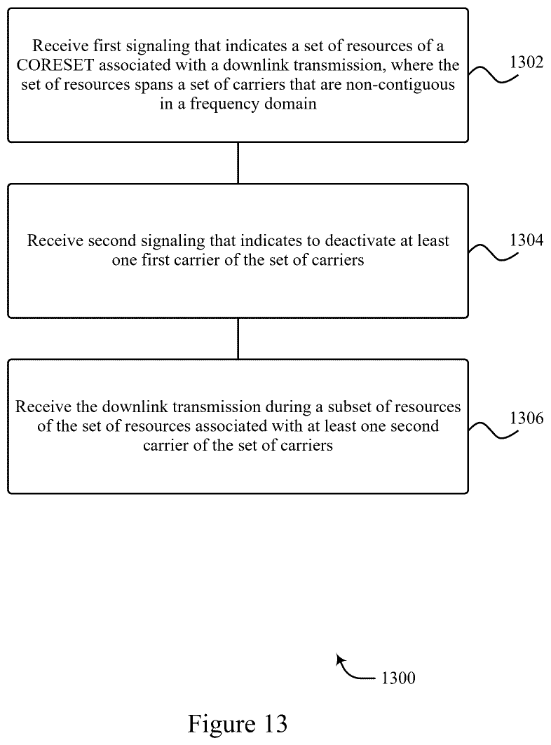

FIG. 13 illustrates a flowchart of a method 1300 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1302, the method may include receiving first signaling that indicates a set of resources of a CORESET associated with a downlink transmission, where the set of resources spans a set of carriers that are non-contiguous in a frequency domain. The operations of 1302 may be performed in accordance with examples as described herein. In some implementations, aspects of the operations of 1302 may be performed by a UE as described with reference to FIG. 10.

At 1304, the method may include receiving second signaling that indicates to deactivate at least one first carrier of the set of carriers. The operations of 1304 may be performed in accordance with examples as described herein. In some implementations, aspects of the operations of 1304 may be performed by a UE as described with reference to FIG. 10.

At 1306, the method may include receiving the downlink transmission during a subset of resources of the set of resources associated with at least one second carrier of the set of carriers. The operations of 1306 may be performed in accordance with examples as described herein. In some implementations, aspects of the operations of 1306 may be performed a UE as described with reference to FIG. 10.

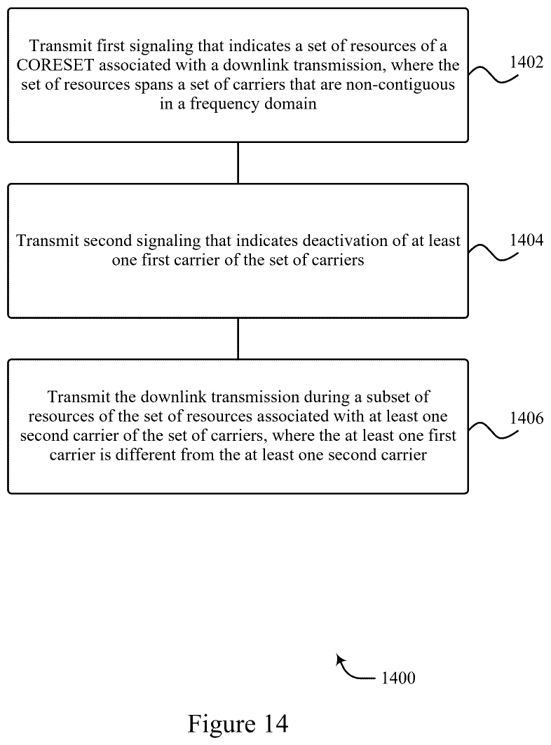

FIG. 14 illustrates a flowchart of a method 1400 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1402, the method may include transmitting first signaling that indicates a set of resources of a CORESET associated with a downlink transmission, where the set of resources spans a set of carriers that are non-contiguous in a frequency domain. The operations of 1402 may be performed in accordance with examples as described herein. In some implementations, aspects of the operations of 1402 may be performed by an NE as described with reference to FIG. 12.

At 1404, the method may include transmitting second signaling that indicates deactivation of at least one first carrier of the set of carriers. The operations of 1404 may be performed in accordance with examples as described herein. In some implementations, aspects of the operations of 1404 may be performed by an NE as described with reference to FIG. 12.

At 1406, the method may include transmitting the downlink transmission during a subset of resources of the set of resources associated with at least one second carrier of the set of carriers, where the at least one first carrier is different from the at least one second carrier. The operations of 1406 may be performed in accordance with examples as described herein. In some implementations, aspects of the operations of 1406 may be performed an NE as described with reference to FIG. 12.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive first signaling that indicates a plurality of resources of a control resource set (CORESET) associated with a downlink transmission, wherein the plurality of resources spans a plurality of carriers that are non-contiguous in a frequency domain;
receive second signaling that indicates to deactivate at least one first carrier of the plurality of carriers; and
receive the downlink transmission during a subset of resources of the plurality of resources associated with at least one second carrier of the plurality of carriers.

2. The UE of claim 1, wherein at least one of the first signaling or the second signaling indicates a timer, and wherein the at least one processor is further operable to cause the UE to deactivate, based at least in part on expiry of the timer, the at least one first carrier.

3. The UE of claim 1, wherein the at least one processor is further operable to cause the UE to:
transmit feedback in response to the second signaling; and
deactivate the at least one first carrier for a duration starting from a time offset with respect to at least one of reception of the second signaling or transmission of the feedback, wherein at least one of the first signaling or the second signaling indicates the duration.

4. The UE of claim 1, wherein the at least one processor is further operable to cause the UE to deactivate the at least one first carrier after a duration, wherein at least one of the first signaling or the second signaling indicates the duration.

5. The UE of claim 1, wherein the at least one processor is further operable to cause the UE to transmit third signaling that indicates a capability of the UE to jointly deactivate multiple carriers of the plurality of carriers, wherein the at least one first carrier comprises the multiple carriers based at least in part on the capability.

6. The UE of claim 1, wherein the at least one processor is further operable to cause the UE to transmit third signaling that indicates a maximum counter value over a duration associated with deactivation and reactivation of respective carriers of the plurality of carriers.

7. The UE of claim 1, wherein the first signaling indicates a maximum numerical quantity of downlink transmission candidates to monitor within the CORESET, wherein the plurality of resources comprises a plurality of control channel elements (CCEs), and wherein to receive the downlink transmission, the at least one processor is operable to cause the UE to apply, based at least in part on the second signaling, a CCE to downlink transmission candidate mapping.

8. The UE of claim 7, wherein the second signaling comprises at least one parameter that indicates to apply the CCE to downlink transmission candidate mapping or an additional CCE to downlink transmission candidate mapping.

9. The UE of claim 7, wherein the at least one processor is further operable to cause the UE to determine the CCE to downlink transmission candidate mapping based at least in part on a numerical quantity of available CCEs at a time deactivating the at least one first carrier.

10. The UE of claim 7, wherein downlink transmission candidates associated with the downlink transmission are within respective carriers of the plurality of carriers based at least in part on the CCE to downlink transmission candidate mapping.

11. The UE of claim 7, wherein downlink transmission candidates associated with the downlink transmission are distributed across the at least one second carrier based at least in part on the CCE to downlink transmission candidate mapping.

12. The UE of claim 7, wherein to apply the CCE to downlink transmission candidate mapping, the at least one processor is further operable to cause the UE to map downlink transmission candidates associated with the downlink transmission based at least in part on the maximum numerical quantity of downlink transmission candidates and one or more available CCEs, wherein the subset of resources of the plurality of resources comprises the one or more available CCEs.

13. The UE of claim 7, wherein to apply the CCE to downlink transmission candidate mapping, the at least one processor is further operable to cause the UE to discard one or more downlink transmission candidates of a plurality of downlink transmission candidates associated with the downlink transmission based at least in part on the one or more downlink transmission candidates being associated with the at least one first carrier.

14. The UE of claim 1, wherein the plurality of resources comprises a plurality of control channel elements (CCEs), wherein a CCE comprises a plurality of resource element group (REG) bundles, wherein a REG bundle comprises a plurality of contiguous REGs, and wherein a REG comprises a plurality of contiguous resource elements (REs) or subcarriers in a symbol, and wherein to receive the downlink transmission, the at least one processor is operable to cause the UE to apply, based at least in part on the second signaling, a CCE to REG mapping.

15. The UE of claim 14, wherein the second signaling comprises at least one parameter that indicates to apply a first CCE to REG mapping or a second CCE to REG mapping, wherein the first CCE to REG mapping is an interleaved mapping and the second CCE to REG mapping is a non-interleaved mapping.

16. The UE of claim 1, wherein the second signaling indicates that the at least one first carrier is deactivated for at least one of the downlink transmission or a data transmission.

17. The UE of claim 1, wherein the plurality of carriers are associated with a first demodulation reference signal (DMRS) pattern, and wherein the at least one processor is further operable to cause the UE to apply, based at least in part on the second signaling, a second DMRS pattern to the at least one second carrier, wherein the first DMRS pattern is different from the second DMRS pattern.

18. A method performed by a user equipment (UE), the method comprising:
receiving first signaling that indicates a plurality of resources of a control resource set (CORESET) associated with a downlink transmission, wherein the plurality of resources spans a plurality of carriers that are non-contiguous in a frequency domain;
receiving second signaling that indicates to deactivate at least one first carrier of the plurality of carriers; and
receiving the downlink transmission during a subset of resources of the plurality of resources associated with at least one second carrier of the plurality of carriers.

19. A network equipment (NE) for wireless communication, comprising:
at least one memory; and
at least one processor coupled with the at least one memory and operable to cause the NE to:
transmit first signaling that indicates a plurality of resources of a control resource set (CORESET) associated with a downlink transmission, wherein the plurality of resources spans a plurality of carriers that are non-contiguous in a frequency domain;
transmit second signaling that indicates deactivation of at least one first carrier of the plurality of carriers; and
transmit the downlink transmission during a subset of resources of the plurality of resources associated with at least one second carrier of the plurality of carriers, wherein the at least one first carrier is different from the at least one second carrier.

20. A method performed by a network equipment (NE), the method comprising:
transmitting first signaling that indicates a plurality of resources of a control resource set (CORESET) associated with a downlink transmission, wherein the plurality of resources spans a plurality of carriers that are non-contiguous in a frequency domain;
transmitting second signaling that indicates deactivation of at least one first carrier of the plurality of carriers; and
transmitting the downlink transmission during a subset of resources of the plurality of resources associated with at least one second carrier of the plurality of carriers, wherein the at least one first carrier is different from the at least one second carrier.
